(19) United States
(12) Patent Application Publication
(10) Pub. No.: US 2012/0080879 A1
(43) Pub. Date: Apr. 5, 2012

(54) CONNECTOR ASSEMBLIES AND KITS FOR CONDUITS

(76) Inventor: Sébastien Gauthier, (US)

(21) Appl. No.: 13/248,175

(22) Filed: Sep. 29, 2011

Related U.S. Application Data
(60) Provisional application No. 61/404,434, filed on Oct. 1, 2010.

(30) Foreign Application Priority Data
Nov. 10, 2010 (CA) 2720537

(51) Int. Cl. F16L 41/14; B23P 17/00

(52) U.S. Cl. 285/197; 29/428

(57) ABSTRACT

A connector assembly for connecting a second conduit to a first conduit is disclosed. The connector assembly comprises a rigid insert comprising a flange and a first annular portion. The first annular portion defines a bore comprising a threaded portion. The flange is configured to be positioned through an opening formed in a wall of the first conduit. The connector assembly comprises a sleeve comprising an arcuate base. A portion of the arcuate base is configured to contact an outer perimeter of the first conduit proximate to the opening. The connector assembly comprises a second annular portion extending from the arcuate base and a cylindrical portion comprising threads thereon. The threads are configured to threadably engage the threaded portion of the bore. The connector assembly comprises a threaded fastening member configured to be threadably engaged with the threads.

### PRIORITY CLAIM

The present application:

(1) claims priority to U.S. provisional patent application Ser. No. 61/404,434, filed Oct. 1, 2011, entitled “Connector Assemblies and Kits for Conduits,” by inventor Sébastien Gauthier; and

(2) claims priority to Canadian patent application no. 2720537, filed Nov. 10, 2011, entitled “Connector Assemblies and Kits for Conduits,” by inventor Sébastien Gauthier.

### FIELD

The present disclosure relates generally to connector assemblies and kits for conduits and, more particularly, relates to connector assemblies and kits configured to be used to connect one conduit (e.g., a service conduit) to another conduit (e.g., a main conduit).

### BACKGROUND

Gravity-type conduit conveyance systems for waste water, storm water, or other liquids often comprise a main conduit to which service conduits are connected. Many applications call for the connection of service conduits that are perpendicular, or substantially perpendicular, to the main conduit. Such connections are often referred to as “Tee” connections or lateral connections. Alternatively, the service conduits may also be connected to the main conduit at a non-90 degree angle and, in some instances, at a 45 degree angle. These 45-degree service conduits are designated as “Wye” connection or 45-degree service connection.

Service conduit installations often require a hole to be cut through a wall of the main conduit such that the service conduit may be connected to the main conduit. In various instances, it may be important to control the depth of penetration of an adapter or a service conduit into the main conduit when a connection is made between the service conduit and the main conduit. In fact, many municipalities specify that a high percentage of the main conduit must remain clear after installation of the service conduit so that normal flow through the main conduit is not impeded, and so that sufficient clearance is provided to allow the passage of remote inspection devices through the main conduit past the service conduit.

In addition to minimizing the amount of penetration of the adapter or service conduit into the main conduit, it may be desirable to ensure that the service conduit is adequately sealed to the main conduit. The sealing aspect of such service conduit is subject to increasingly rigorous testing, including air and/or water pressure testing, as part of an inspection approval process.

### SUMMARY

In one general aspect, the present disclosure is directed, in part, to a connector assembly for connecting a second conduit (e.g., service conduit) to a first conduit (e.g., main conduit). The connector assembly comprises a rigid insert comprising a flange and a first annular portion extending from the flange. The first annular portion defines a bore comprising a threaded portion. The flange is configured to be positioned within the first conduit through an opening formed in a wall of the first conduit. The rigid insert comprises a lobe portion extending from the flange and positioned proximate to the first annular portion. The connector assembly comprises a sleeve comprising an arcuate base. A portion of the arcuate base is configured to contact an outer perimeter of the first conduit proximate to the opening. A second annular portion extends from the arcuate base. The connector assembly comprises a cylindrical portion comprising threads thereon. The threads are configured to threadably engage the threaded portion of the bore. The cylindrical portion is configured to receive an end or an end portion of the second conduit. The connector assembly comprises a threaded fastening member configured to be threadably engaged with the threads.

In one general aspect, the present disclosure is directed, in part, to a connector assembly kit for connecting a second conduit to a first conduit. The connector assembly kit comprises a plurality of rigid inserts: comprising a first rigid insert having a first configuration for use with a conduit having a first diameter; and a second rigid insert having a second configuration for use with a conduit having a second diameter. Each rigid insert comprises a rigid flange and a first rigid annular portion extending from the rigid flange. The first rigid annular portion defines a bore comprising a threaded portion. The rigid flange is configured to be positioned within the first conduit through an opening formed in a wall of the first conduit. The connector assembly kit comprises a universal sleeve that may comprise an arcuate base. A portion of the arcuate base is configured to contact an outer perimeter of the first conduit proximate to the opening. The universal sleeve comprises a second annular portion extending from the arcuate base. An aperture is defined through the arcuate base and the second annular portion. The universal sleeve is configured to be positioned over the first rigid insert or the second rigid insert. The connector assembly kit comprises a cylindrical portion comprising threads thereon. The threads are configured to threadably engage the threaded portion of the bore. The cylindrical portion is configured to receive an end or end portion of the second conduit. The connector assembly kit comprises a threaded fastening member configured to be threadably engaged with the threads and a drill guide that comprises a support member and at least one drill bit receiving member defining a bore therein.

In one general aspect, the present disclosure is directed, in part, to a method of attaching a service conduit to a conduit having a longitudinal axis using a connector assembly kit. The method comprises: positioning a drill guide on the conduit such that a longitudinal axis of the drill guide is substantially parallel with the longitudinal axis of the conduit; drilling a first pilot hole in the conduit using a drill bit and a first bore in the drill guide; drilling a second pilot hole in the conduit using the drill bit and a second bore in the drill guide; and removing the drill guide from the conduit. The method comprises cutting a first hole in the conduit using the first pilot hole and cutting a second hole in the conduit using the second pilot hole. The first and second holes overlap each other. In various embodiments, the first hole is cut with a first hole saw prior to cutting the second hole with a second hole saw. The method comprises inserting a rigid insert into the aperture formed by the first hole and the second hole, positioning a rigid flange of the rigid insert within the conduit, and positioning a universal sleeve over a portion of the rigid insert that extends outside of the conduit. The method comprises attaching a cylindrical portion to the rigid insert and inserting an end of the service conduit into a bore defined by the cylindrical portion to sealably connect the conduit and the service conduit.

### BRIEF DESCRIPTION OF THE FIGURES

Various non-limiting embodiments of the present disclosure are described herein, by way of example, in conjunction with the following figures, wherein:

FIGS. 1 and 2 are exploded a perspective views of a connector assembly for connecting a second conduit to a first conduit in accordance with one non-limiting embodiment of the present disclosure;

FIG. 3 is a perspective view of the connector assembly of FIG. 1 installed on a main conduit (main conduit is cut-away for illustration) in accordance with one non-limiting embodiment of the present disclosure;

FIG. 4 is a photograph of a connector assembly installed on a main conduit in accordance with one non-limiting embodiment of the present disclosure;

FIG. 5 is a perspective view of a main conduit onto which a connector assembly may be attached through the use of a connector assembly kit;

FIG. 6 is a perspective view of a drill guide positioned on the main conduit of FIG. 5 in accordance with one non-limiting embodiment of the present disclosure;

FIG. 7 is a perspective view the main conduit of FIG. 6 after pilot holes have been drilled using the drill guide in accordance with one non-limiting embodiment of the present disclosure;

FIG. 8 is a perspective view of the main conduit of FIG. 7 with a first hole cut in the main conduit in accordance with one non-limiting embodiment of the present disclosure;

FIG. 9 is a perspective view of the main conduit of FIG. 8 with a second hole cut in the main conduit in accordance with one non-limiting embodiment of the present disclosure;

FIG. 10 is a perspective view of an insert and an insert gasket in accordance with one non-limiting embodiment of the present disclosure;

FIG. 11 is a perspective view of the insert and insert gasket of FIG. 10 partially inserted into the first and second holes in the main conduit in accordance with one non-limiting embodiment of the present disclosure;

FIG. 12 is a perspective view of the insert positioned within the first and second holes in the main conduit and the sleeve positioned over a portion of the insert in accordance with one non-limiting embodiment of the present disclosure;

FIG. 13 is a perspective view of the insert positioned within the first and second holes in the main conduit and the sleeve positioned over a portion of the insert in accordance with one non-limiting embodiment of the present disclosure;

FIGS. 14-16 are perspective views of the insert positioned within the first and second holes in the main conduit, the sleeve positioned over a portion of the insert, and the cylindrical portion being attached to the insert in accordance with one non-limiting embodiment of the present disclosure;

FIGS. 17-21 are views of an insert in accordance with one non-limiting embodiment of the present disclosure;

FIGS. 22-25 are views of an insert gasket in accordance with one non-limiting embodiment of the present disclosure;

FIGS. 26-31 are views of a sleeve in accordance with one non-limiting embodiment of the present disclosure;

FIGS. 32 and 33 are views of a cylindrical portion in accordance with one non-limiting embodiment of the present disclosure;

FIGS. 34 and 35 are views of a second gasket in accordance with one non-limiting embodiment of the present disclosure;

FIGS. 36 and 37 are views of a first gasket in accordance with one non-limiting embodiment of the present disclosure;

FIGS. 38 and 39 are views of a threaded fastening member in accordance with one non-limiting embodiment of the present disclosure;

FIGS. 40-43 are views of a connector assembly installed on a main conduit (main conduit is cut-away for illustration) in accordance with one non-limiting embodiment of the present disclosure; and

FIGS. 44-49 are views of a drill guide in accordance with one non-limiting embodiment of the present disclosure.

### DETAILED DESCRIPTION

Various non-limiting embodiments of the present disclosure will now be described to provide an overall understanding of the principles of the structure, function, manufacture, and use of connector assemblies and kits for conduits disclosed herein. One or more examples of these non-limiting embodiments are illustrated in the accompanying drawings. It will be appreciated that the connector assemblies and connector assembly kits for conduits specifically described herein and illustrated in the accompanying drawings are non-limiting example embodiments and that the scope of the various non-limiting embodiments of the present disclosure are defined solely by the claims. The features illustrated or described in connection with one non-limiting embodiment may be combined with the features of other non-limiting embodiments. Such modifications and variations are intended to be included within the scope of the present disclosure.

Conventional service conduit connections to main conduits generally comprise elastomeric or flexible connection assemblies and/or inserts. (The main conduits described herein may also be referred to as conduits or first conduits.) These type of connector assemblies and/or inserts are usually required because a rigid connection assembly or insert of a connector assembly will not fit within a bore in a wall of the main conduit owing to the diameter of the bore and the diameter required of the insert to properly seal the service conduit to the main conduit about the bore. Stated another way, a flexible insert is used because a rigid insert would not be able to be placed through the bore into the main conduit at least partially owing to the flange of the insert. Furthermore, when this type of non-rigid connector assembly is used, it is specific to the size or diameter of the main conduit and the size or diameter of the service conduit. For example, if a main conduit has a diameter of fifteen inches and a service conduit has a diameter of six inches, the connector assembly required would be fifteen inches by six inches. This connector assembly would not work or fit properly on a main conduit having a diameter of 42 inches, for example. Thus, conventional connector assemblies are specific to the size or diameter of the main conduit and are not adaptable for various sizes or diameters of main conduits. Instead, a whole new connector assembly must be purchased for a differently sized main conduit.

In various embodiments, the present disclosure provides connector assemblies and connector assembly kits for conduits that are more universal and that may be used with main conduits having diameters within the range of about eight inches to about forty-two inches or larger. The connector assemblies and connector assembly kits of the present disclosure may be used to connect service conduits or service connections to main conduits. In various embodiments, the service conduits may be connected to the main conduit through a tee or lateral connection, a Wye connection, and/or other suitable connection. The connector assemblies and connector assembly kits may be used with main conduits comprised of thermoplastic, cement, clay, metal, profile pipe, and/or flat pipe, for example. In one embodiment, a connector assembly kit may comprise four inserts. In various embodiments, the inserts may be rigid, while in other embodiments, portions of the inserts may be rigid. The four inserts may be used with main conduits having different diameters or the same diameters. In various embodiments, a first insert may be used on a main conduit having a diameter of about eight inches, a second insert may be used on a main conduit having a diameter in the range of about ten inches to about twelve inches, a third insert may be used on a main conduit having a diameter in the range of about fifteen inches to about twenty-one inches or to about twenty-four inches, and a fourth insert may be used on a main conduit having a diameter in the range of about twenty-four inches or about twenty-seven inches to about forty-two inches or, above about forty-two inches. In one embodiment, the above four inserts may be provided in a kit for a four inch service connection, for example.

In one embodiment, another four inserts may be provided in a kit for a six inch service connection. In such an embodiment, a first insert may be used on a main conduit having a diameter of about ten inches, a second insert may be used on a main conduit having a diameter of about twelve inches, a third insert may be used on a main conduit having a diameter in the range of about fifteen inches to about twenty-one inches or to about twenty-four inches, and a fourth insert may be used on a main conduit having a diameter in the range of about twenty-four inches or about twenty-seven inches to about forty-two inches or, above about forty-two inches. In one embodiment, a first insert for an about eight inch service connection may be used on an about twelve inch diameter main conduit, for example, with the second, third, and/or fourth inserts being used on main conduits having diameters larger than about twelve inches. In various embodiments, other suitable inserts may be provided in a kit for other sized service connections. As such, the present disclosure is not limited to the sizes or size ranges of the inserts described above. Such sizes and size ranges are merely provided as example embodiments. Any suitable number of inserts may be provided in a kit. In one embodiment, only one insert may be provided in a kit. In such an embodiment, any of the first insert, the second insert, the third insert, the fourth insert, or another suitable insert may be provided in the kit as the sole insert.

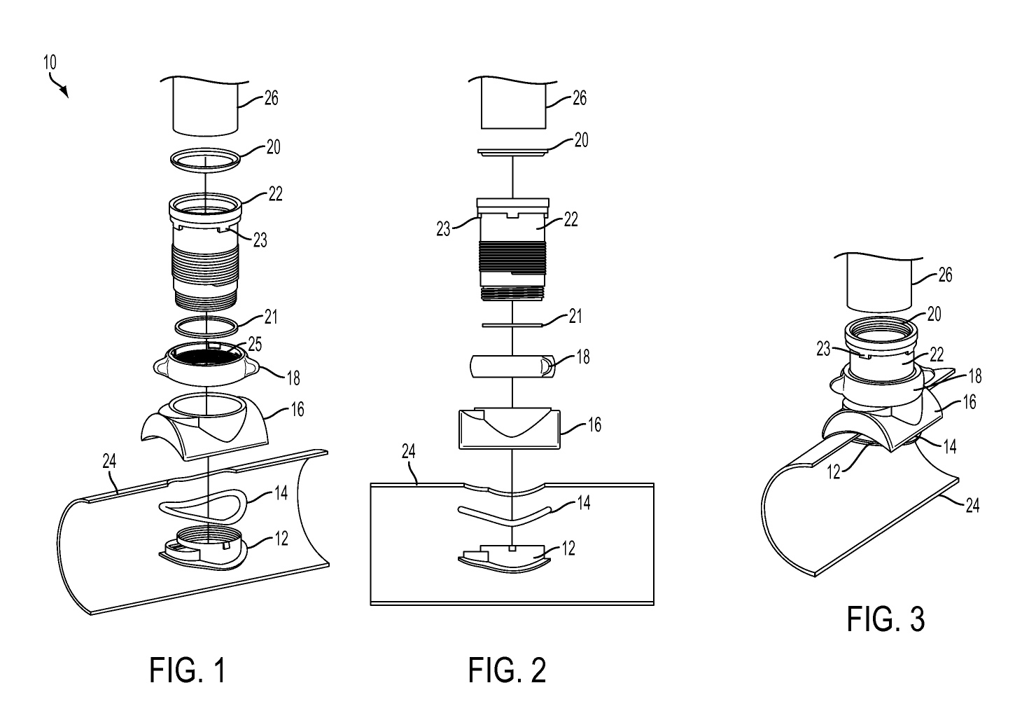

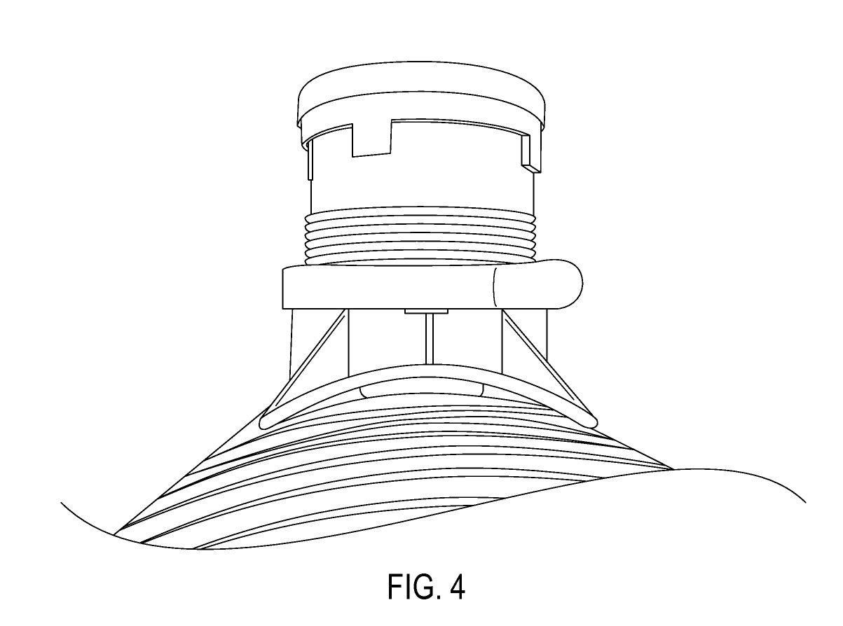

In one embodiment, referring to FIGS. 1-3, a connector assembly 10 of the present disclosure is illustrated. The connector assembly 10 may comprise an insert 12, an insert gasket 14, a sleeve or a universal sleeve 16, a threaded fastening member 18, a first gasket 20, a cylindrical portion 22, and a second gasket 21. In various embodiments, the gaskets may be eliminated or formed with or on other components. In still other various embodiments, the various components may comprise resilient or elastomeric portions that are configured to create a seal. Each of the various components will be described in further detail below. In FIGS. 1-3, the main conduit 24 is cut-away for clarity in illustration and only a portion of the service connection or conduit 26 is illustrated. In one embodiment, FIG. 4 illustrates a connector assembly engaged with a main conduit.

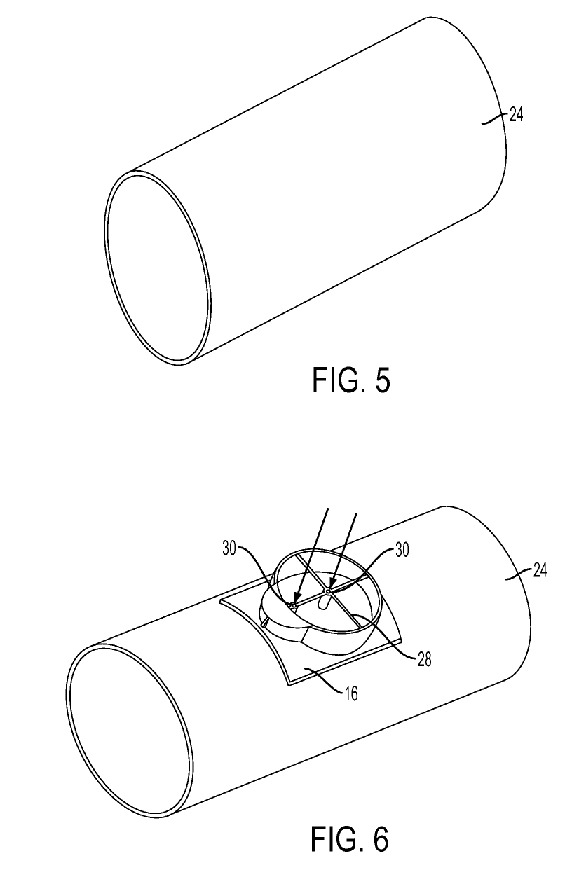

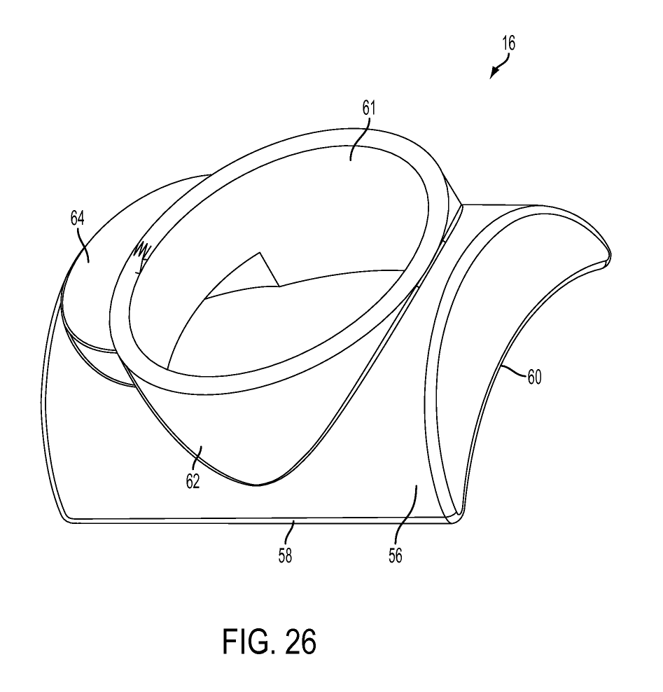

To illustrate the method of using the connector assemblies and connector assembly kits of the present disclosure and how the connector assemblies are installed on a main conduit, a progression of the installation will be discussed prior to the discussion of each individual component for clarity. In one embodiment, referring to FIG. 5, a main conduit 24 is illustrated. Initially, referring to FIG. 6, the sleeve 16 may be placed on the main conduit 24. In one embodiment, the sleeve 16 may comprise a drill guide 28 removably attached thereto, positionable thereon, and/or formed therewith. Other embodiments of a drill guide will be described in greater detail below. The drill guide 28 defines bores 30 configured to receive a drill bit. The bores 30 may be aligned with a longitudinal axis of the main conduit 24 owing to side walls (see e.g., FIG. 26, #58) of an arcuate base 32 of the sleeve 16 engaging an outer side wall of the main conduit 24. Such engagement will allow the bores 30 to be positioned along the longitudinal axis of the main conduit 24 in a straight line. The drill guide 28 will also permit pilot holes drilled through the bores 30 to be perpendicular to, or substantially perpendicular to, the longitudinal axis of the main conduit 24. In one embodiment, there may be one or two bores 30 on the drill guide 28 or, in other embodiments, there may be three or more bores 30 on the drill guide. In most installations, only two pilot holes 34 may be drilled in the main conduit 24, although three bores 30 may be provided on the drill guide 28 to accommodate main conduits 24 with different diameters. Different diameter main conduits may require different spacing between the pilot holes. As such, three or more bores 30 may be provided on the drill guide 28 to accommodate various applications.

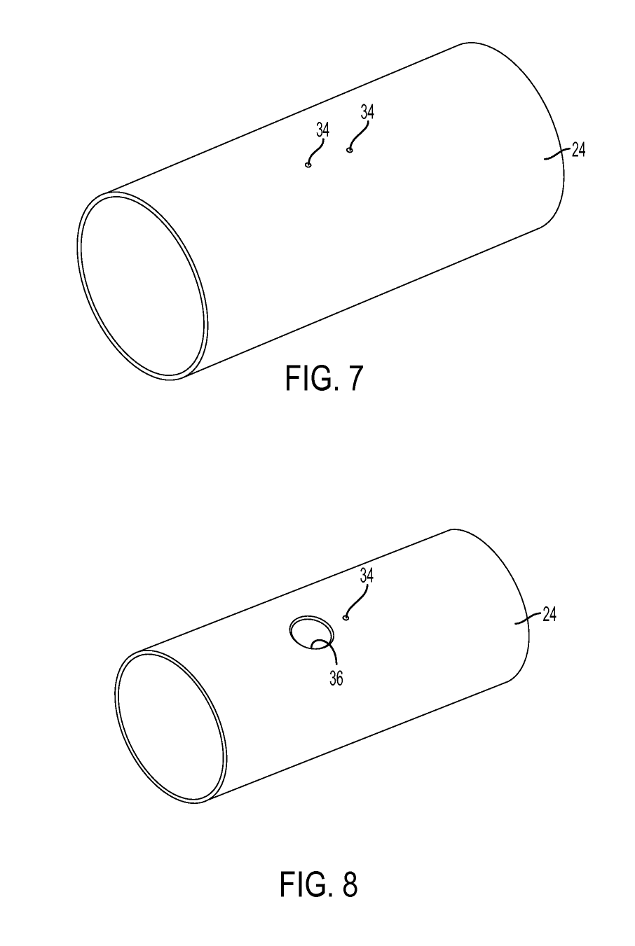

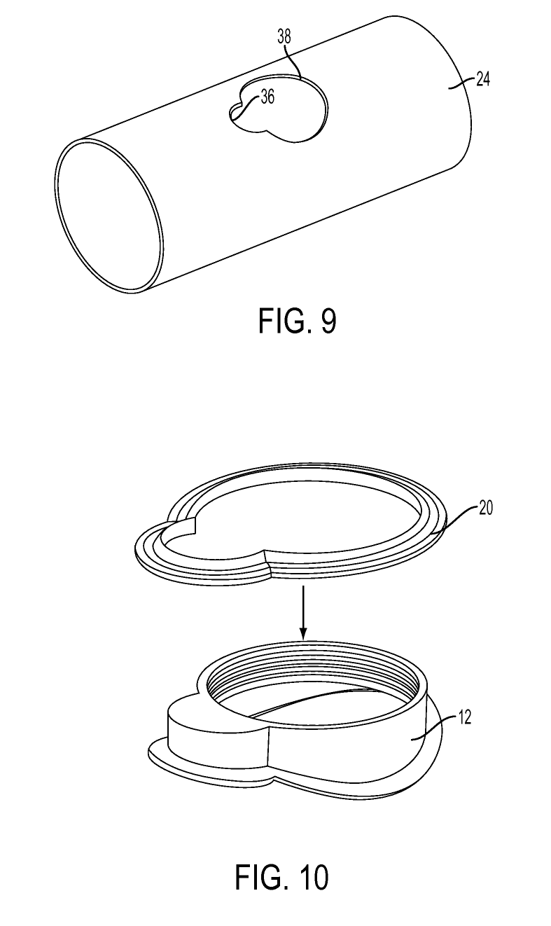

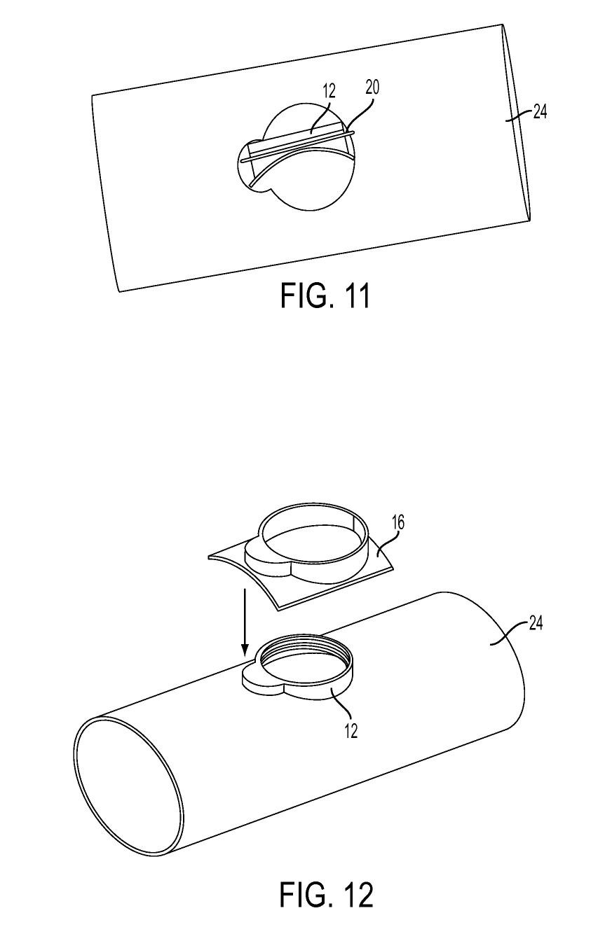

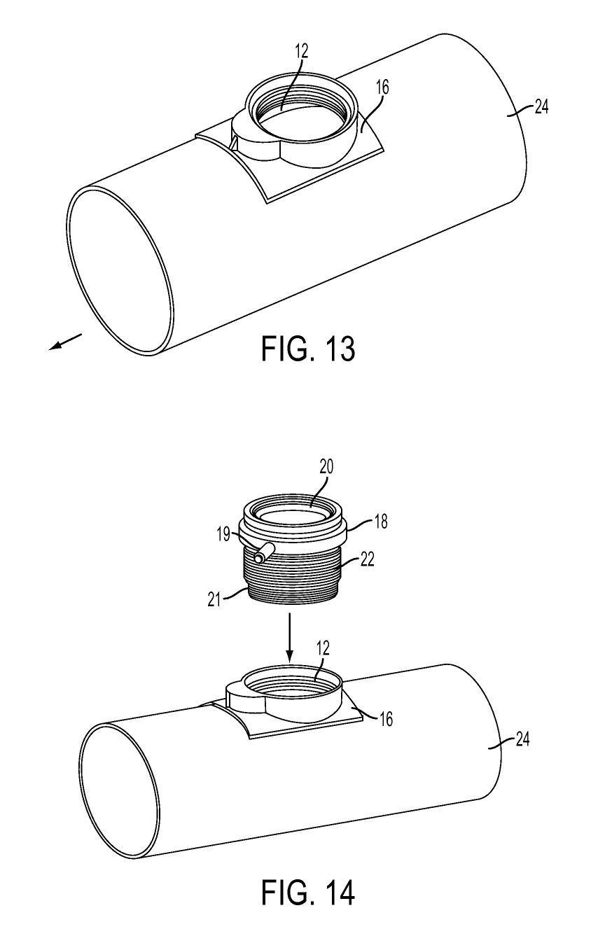

In one embodiment, referring to FIG. 7, once the pilot holes 34 are drilled, the sleeve 16 may be removed from the main conduit 24 and the drill guide 28 may be broken away from the sleeve 16 and discarded or, in other embodiments, removed from the sleeve 16 and reused in another installation. Next, referring to FIG. 8, a first hole saw or other cutting device may be used to create a first hole 36, such as a round hole, in the wall of the main conduit 24. A drill bit of the first hole saw may be inserted into one of the pilot holes 34 to create the first hole 36. In various embodiments, referring to FIG. 9, a second hole saw or other cutting device may be used to create a second hole 38, such as a round hole, in the wall of the main conduit 24. A drill bit of the second hole saw may be inserted into the other of the pilot holes 34 to create the second hole 36. In one embodiment, the second hole and the first hole may partially overlap to form a “lobed circle,” as illustrated in FIG. 9. The first and second holes form an aperture configured to receive the insert 12 therethrough or at least partially therethrough. Next, referring to FIGS. 10-12, the insert gasket 20 may be positioned on the insert 12 and then the insert 12 may be positioned at least partially within the first and second holes 36 and 38 and then rotated into the position illustrated in FIG. 12, such that a flange 42 of the insert 12 is positioned inside the main conduit 24 and an annular portion 40 of the insert 12 extends out of the main conduit 24 through the first and second holes 36 and 38. In one embodiment, the insert 12 may comprise a retaining member configured to allow the insert 12 to be retained in the positioned illustrated in FIG. 12 without falling back into the main conduit 24, as discussed in greater detail below. Next, the sleeve 16 may be positioned over the insert 12 as illustrated in FIG. 13. In one embodiment, the sleeve 16 may be configured to be engaged with or be snap-fit with the insert 12 to hold the insert 12 within the first and second holes 36 and 38 without the insert 12 falling into the main conduit 24. Next, referring to FIG. 14, the first gasket 20, the second gasket 21, and the threaded fastening member 18 may be positioned on the cylindrical portion 22. In other various embodiments, the first gasket 20, the second gasket 21, and the threaded fastening member 18 may be provided assembled with the cylindrical portion 22. In one embodiment, referring to FIGS. 14-16, it is illustrated how the cylindrical portion 22 is engaged, or threadably engaged, and tightened to the insert 12 using the threaded fastening member 18. The threaded fastening member 18 may comprise handle portions 19 used to tighten or rotate the threaded fastening member 18 relative to the cylindrical portion 22. Different embodiments of the components of the connector assemblies of the present disclosure may be illustrated in additional figures, although these components may retain common numbering.

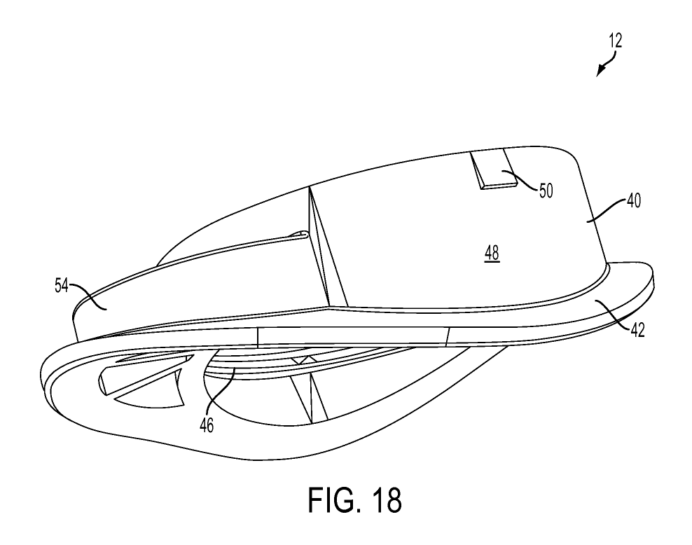

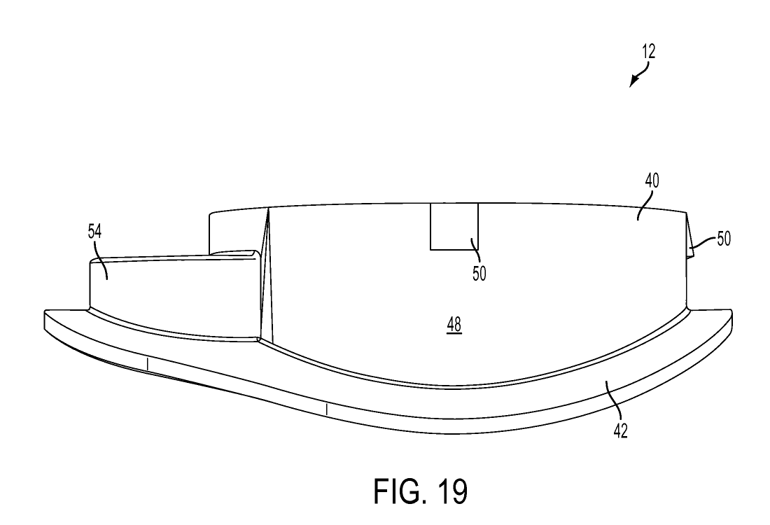

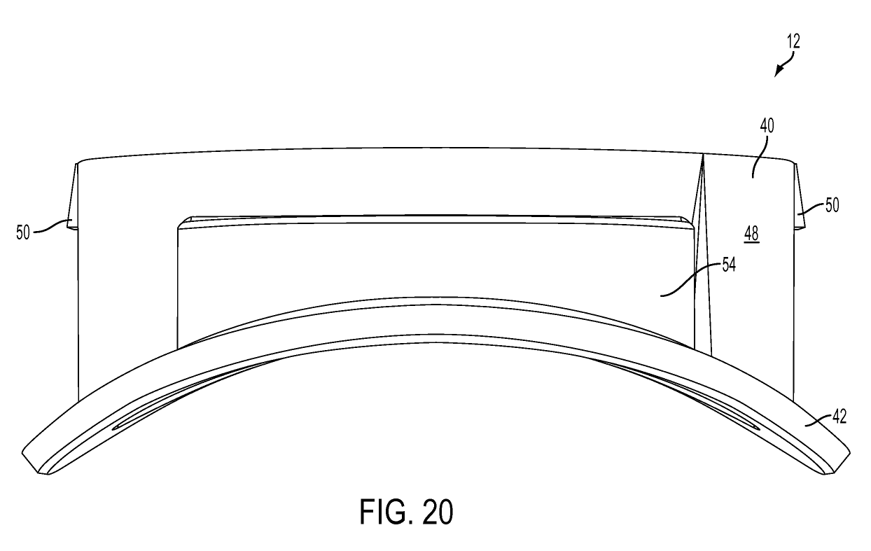

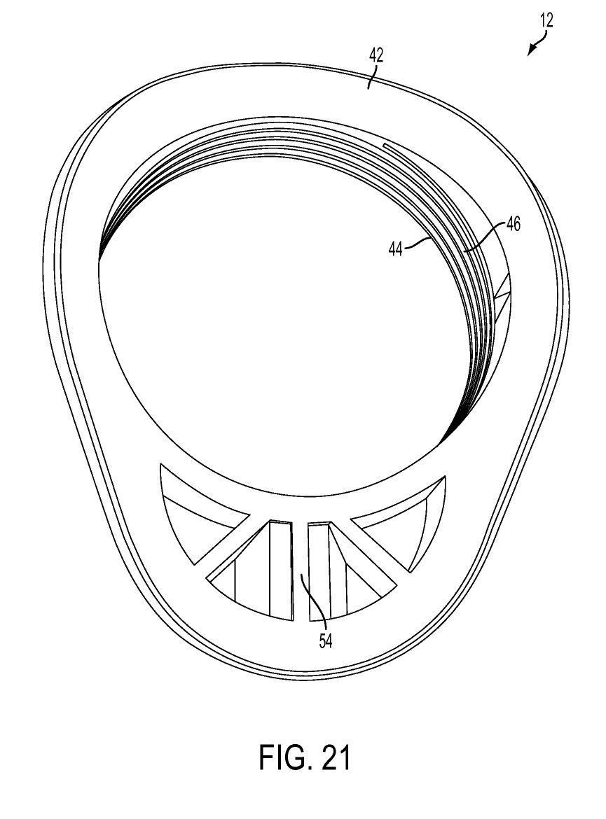

In one embodiment, referring to FIGS. 17-21, the insert or rigid insert 12 may comprise an annular portion 40 extending from a flange 42 configured to receive the insert gasket 14. In various embodiments, the annular portion 40 and/or the flange 42 may be formed of a rigid material. The annular portion 40 may define a bore 44 therethrough comprising a threaded portion 46. In various embodiments, the threaded portion 46 may be present throughout the length of the bore 44 or throughout only a portion of the bore 44. In one embodiment, the threaded portion 46 may be configured to be threadably engaged with threads on the cylindrical portion 22. The flange 42 may be configured and shaped to seat against or be positioned proximate to an inside wall of the main conduit about the first and second holes 36 and 38.

In one embodiment, an outside surface 48 of the annular portion 40 may comprise retaining members 50 thereon. Such retaining members 50 may be positioned around the outside surface 48 of the annular portion 40 and may be configured to engage a wall of the main conduit 24 to prevent the insert 12 from falling into the main conduit 24. In one embodiment, only one retaining member 50 may be provided and, in other embodiments, two or more retaining members 50 may be provided. In various embodiments, the retaining members may comprise teeth, barbs, biasing members, hooks, projections, tapered portions, and/or tabs that are configured to retain the insert 12 to the wall of the main conduit 24 when the insert 12 is inserted into aperture formed by the first hole 36 and the second hole 38. In various other embodiments, retaining members may not be provided on the annular portion 40 and, instead, the sleeve 16 may comprise retaining members configured to engage portions of the insert 12, or apertures of the insert, and retain the insert 12 in the position illustrated in FIG. 12. In one embodiment, the insert 12 may be interlocked with the sleeve 16, for example, using any suitable interlocking features known to those of skill in the art. In still other various embodiments, an adhesive and/or an adhesive/sealant may be placed upon a surface 52 of the flange 42. This adhesive/sealant may hold the insert 12 in the position illustrated in FIG. 12 and also seal the insert 12 to an inside wall of the main conduit 24. In still other various embodiments, a flexible retaining member (not illustrated), such as a rubber band, for example, may be attached to or wrapped around a portion of the insert 12, such that the insert 12 may be prevented from falling into the main conduit 24 when in the position illustrated in FIG. 12. In one embodiment, the flexible retaining member may then be removed, cut, and/or broken away from the insert 12 or left in place on the insert 12.

In one embodiment, still referring to FIGS. 17-21, the insert 12 may comprise a lobe 54. The lobe 54 may extend from the flange 42 and may be attached to the outside surface 48 of the annular portion 40. In various embodiment, one purpose of the lobe 54 is to fill the gap formed by the first hole 36 in the main conduit 24. In one embodiment, the lobe 54 may be formed with the annular portion 40 and/or the flange 42, while in other embodiments, the lobe 54 may be a separate component attached to the annular portion 40 and/or the flange 42. In one embodiment of an insert, a lobe may not be provided and instead a flat portion extending from the annular portion 40 and/or the flange 42 may fill the void created by the first hole 36. In still other various embodiments, the lobe 54 may not be provided and an aperture may exist where the lobe 54 would have been positioned. In such an embodiment, a lobe or flat portion may be formed on the sleeve 16 to fill a portion of the first hole 36 in the main conduit 24 when the sleeve 16 is engaged with or positioned over the insert 12. In one embodiment, a seal may be positioned around the aperture, such that the insert 12 may be sealably engaged with the lobe or flat portion.

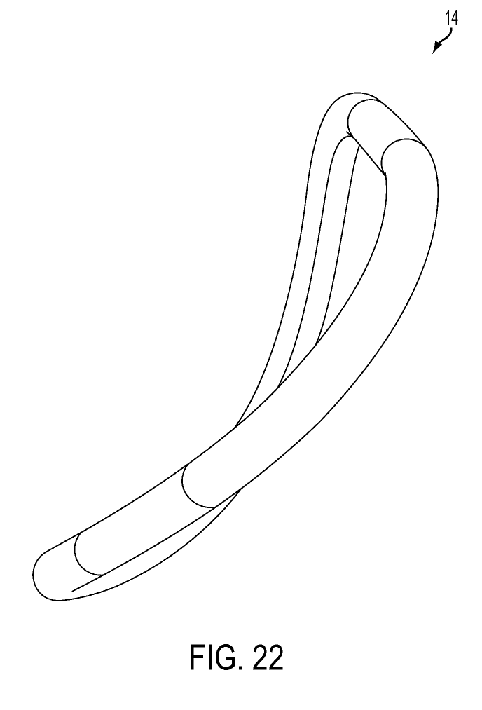

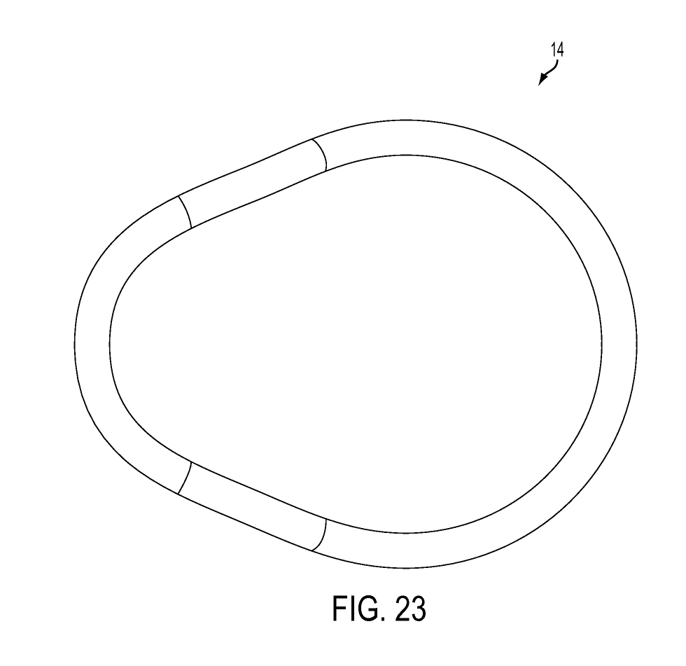

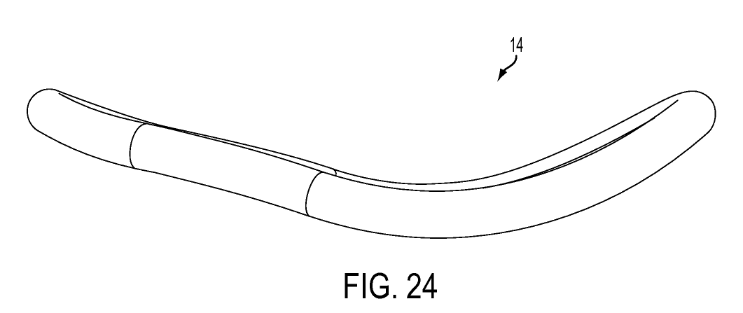

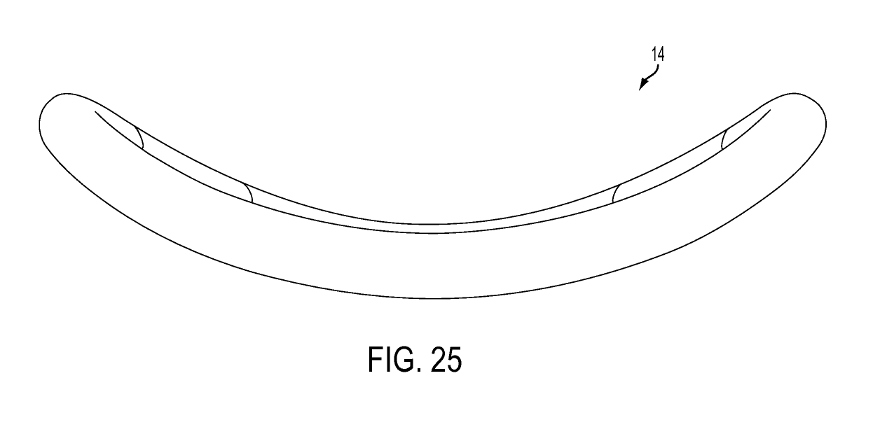

In one embodiment, the flange 42 of the insert 12 may be configured to be abutted with a portion of the inside wall of the main conduit 24 surrounding the first hole 36 and the second hole 38. In various embodiments, the flange 42 may be comprised of a rigid material such that it may not be deformed or substantially deformed. The abutting of the flange 42 with the inside wall of the main conduit 24 may maintain the insert 12 in position and prevent, or at least inhibit, rotation or movement of the insert 24 within the main conduit 24 while the cylindrical portion 22 is being threaded into the threaded portion 46 of the insert 12. In various embodiments, the flange 42 may be configured to receive the insert gasket 14 such that a seal can be created between the flange 42 and the inside wall of the main conduit 24. In one embodiment, referring to FIGS. 22-25, the insert gasket 14 is illustrated. This insert gasket 14 is configured to fit on the flange 42 of the insert 12, as illustrated in FIGS. 1, 2, 10, and 11. In one embodiment, the insert gasket 14 may comprise arcuate portions configured to fit the shape of the flange 42. In other various embodiments, the insert gasket 14 may comprise the form of a typical O-ring and may be shaped to sealably engage the main conduit 24 when the insert gasket 14 is compressed between the flange 42 and an inside surface or wall of the main conduit 24. In one embodiment, the insert gasket 14 may be a universal gasket in that it may be used with an insert for any diameter main conduit. As such, a connector assembly kit may be provided with one insert gasket 14 that will work for all of the inserts 12 within the kit.

In one embodiment, a connector assembly kit may comprise more than one insert 12 or, in one embodiment, four inserts 12. Each insert 12 may have the same sized or a similar sized annular portion 40, such that a single cylindrical portion 22 may fit into each insert 12. In one embodiment, each different insert may comprise a different curvature of the flange or other portions thereof to fit or be positioned against inside walls of main conduits having different sizes. In various embodiments, a first insert 12 may be provided for use with an about 8 inch diameter main conduit, a second insert 12 may be provided for use with a main conduit having a diameter in the range of about ten inches to about twelve inches, a third insert 12 may be provided for use with a main conduit having a diameter in the range of about fifteen inches to about twenty-four inches, and a fourth insert 12 may be provided for use with a main conduit having a diameter in the range of about twenty-four inches to about forty-two inches. Other various inserts 12 for other sizes of main conduits may also be provided, including for main conduits smaller than about 8 inches and larger than about 42 inches. In one embodiment, each insert 12 may be marked or stamped with indicia to indicate to an installer which insert is proper to use with a main conduit having a particular diameter. After the first and/or second hole 36 or 38 are cut into the main conduit 24, a user may measure the inside diameter of the main conduit if he or she is unsure of its size. The connector assembly kit may be provided with the multiple inserts such that it is adaptable to most, if not all, main conduits on a jobsite or in other locations.

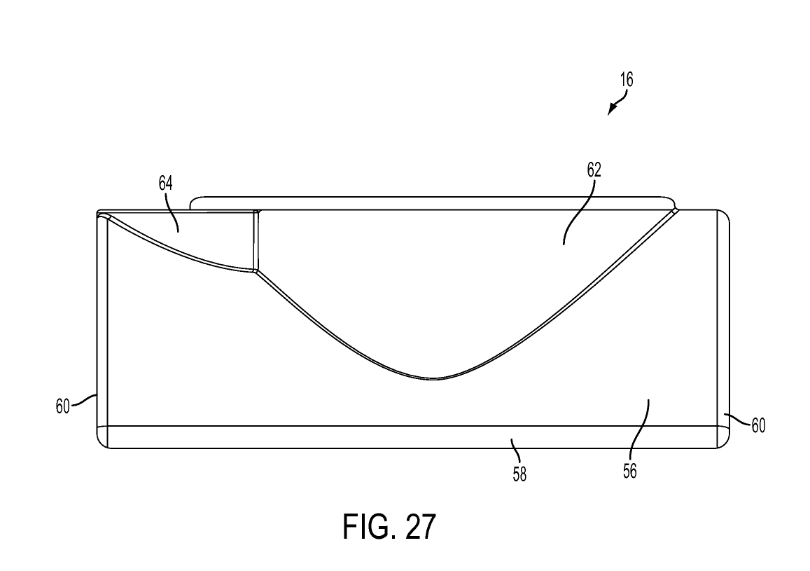

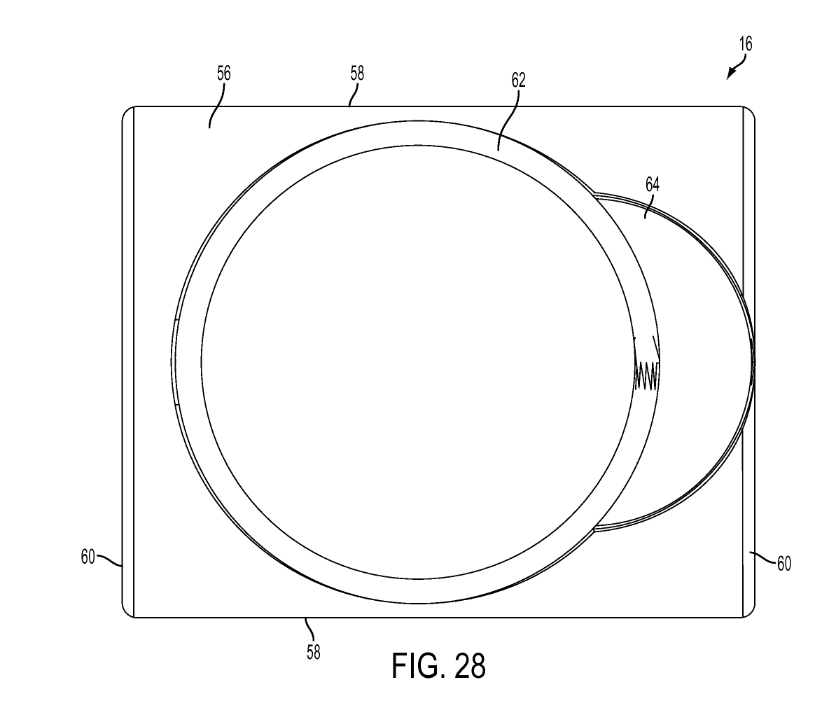

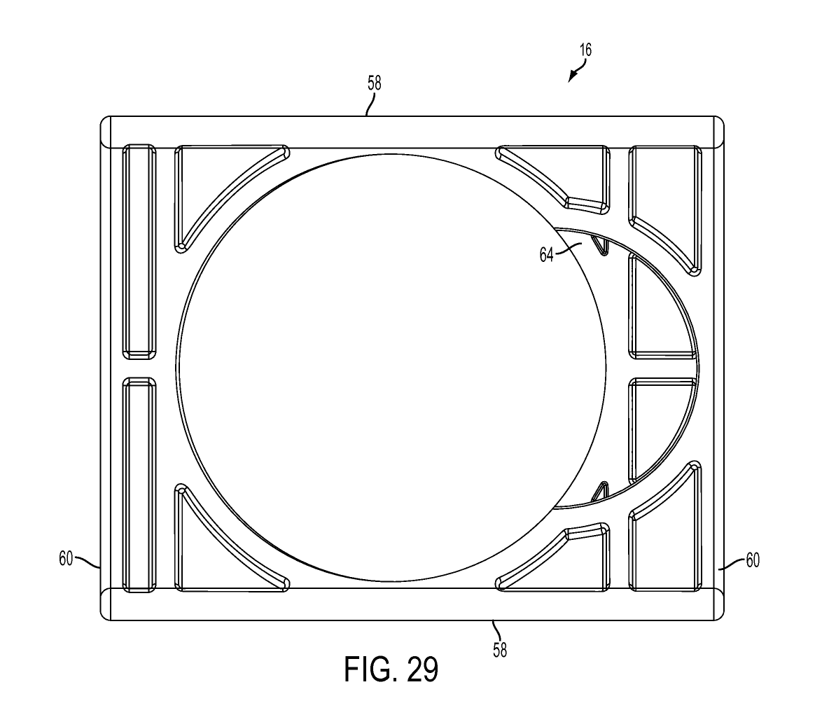

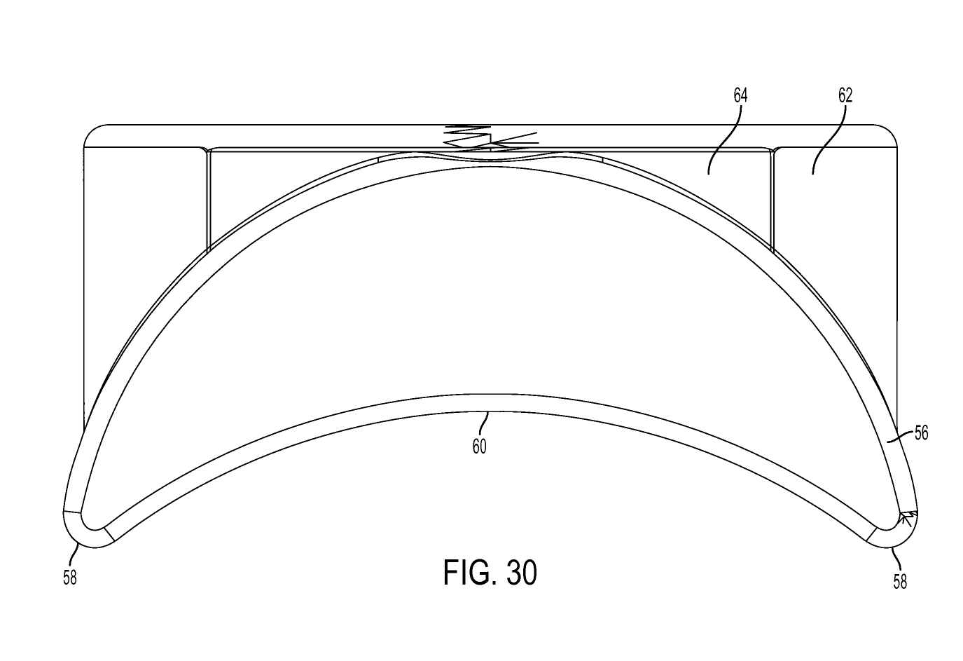

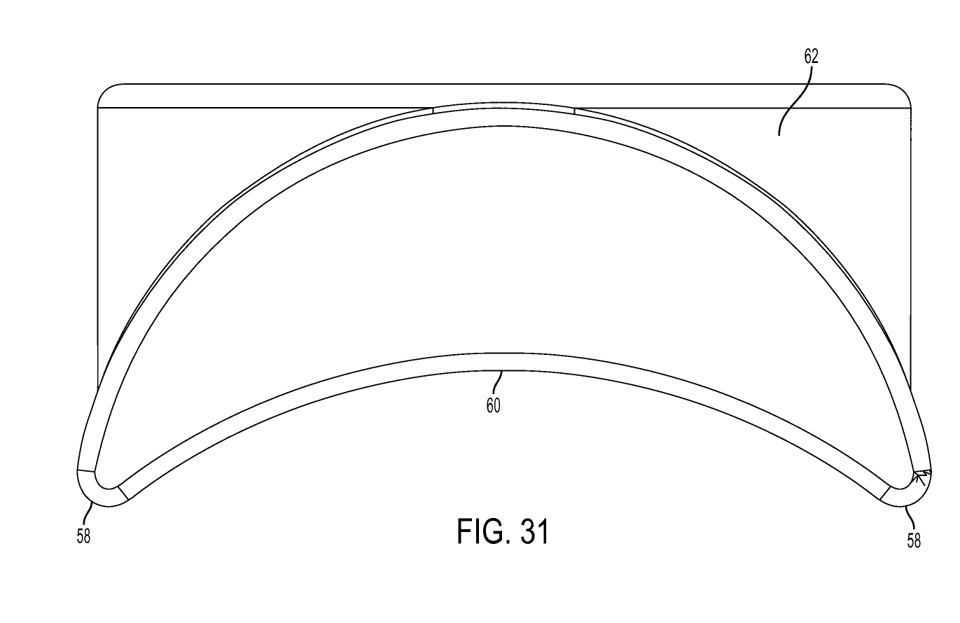

In various embodiments, referring to FIGS. 26-31, the sleeve 16 may be universal so that no matter which insert 12 is selected for use, the sleeve 16 may still be engagable with a portion of the insert 12 or positionable over a portion of the insert 12. In one embodiment, the sleeve 16 may be comprised of rigid or semi-rigid materials and may provide for even, or substantially even, force distribution on the threaded fastening member 18 and/or the main conduit 24 when the cylindrical portion 22 is engaged with the threaded portion 46 of the insert 12 and the threaded fastening member 18 is being rotated or moved. In one embodiment, the sleeve 16 may comprise an arcuate base 56. The arcuate base 56 may conform, or at least partially conform, to a portion of an outer wall of a main conduit, such as a main conduit having an eight inch diameter, for example. For larger diameter main conduits, side walls 58 of the arcuate base 56 may contact the main conduit, while end walls 60 may be arched up and/or spaced from the outer surface of the main conduit. Such an embodiment of the arcuate base 32 is illustrated in FIG. 4. The universal sleeve 16 may be used with any insert 12 owing to the arcuate base 56.

In one embodiment, still referring to FIGS. 26-31, the sleeve 16 may comprise an annular portion 62. An aperture 61 may be defined through the annular portion 62 and the arcuate base 56. The annular portion 62 may fit over and/or around, or at least partially fit over and/or around, the annular portion 40 of the insert 12 (see e.g., FIGS. 12 and 13). The sleeve 16 may comprise a lobe 64 extending from the arcuate base 56 and the annular portion 62. In one embodiment, the lobe 64 may fit at least partially over the lobe 54 of the insert 12. In one embodiment, the lobe may be omitted from the sleeve's design. In place of a lobe, an aperture may be formed in the sleeve where the lobe would have been formed or a portion of the arcuate base may extend where the lobe would have been formed. Whether or not the lobe, aperture, or portion of the arcuate base 56 is provided is dependent on whether the lobe 54 is provided on the insert 12. If the lobe 54 is provided on the insert 12, then the lobe 64 or an aperture may be formed or defined on the sleeve 16. If a flat portion is provided on the insert 12 in place of the lobe 54, then either a portion of the arcuate base 56 or an aperture may be provided on the sleeve 16. If an aperture is provided on the insert 12 in place of the lobe 54, then the lobe 64 or a portion of the arcuate base 56 may be provided on the sleeve 16. In any event, the purpose of the lobes 54 and 64 and/or the flat portions on the insert 12 and the portions of the sleeve 16, respectively, is to essentially block or fill a portion of the first hole 36 when the connector assembly is engaged with the main conduit 24. An additional purpose of the lobes 54 and 64 may be to ensure that the insert 12 is positioned appropriately within the main conduit 24.

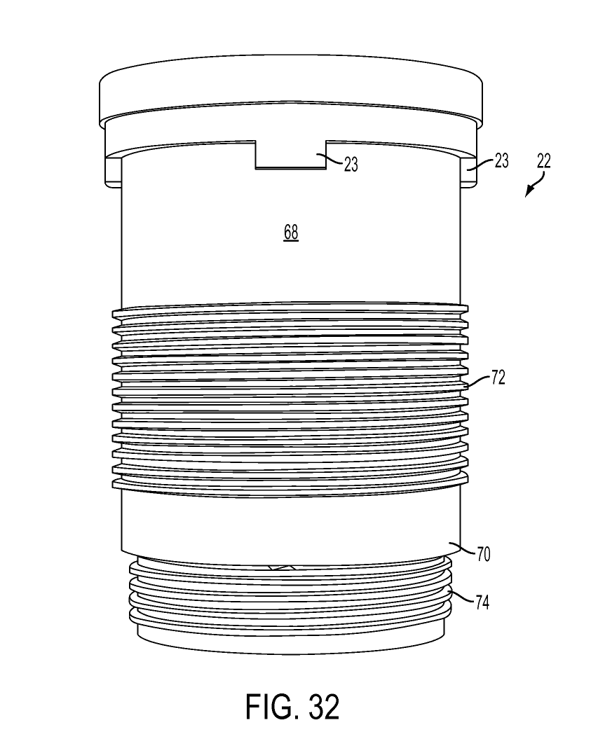

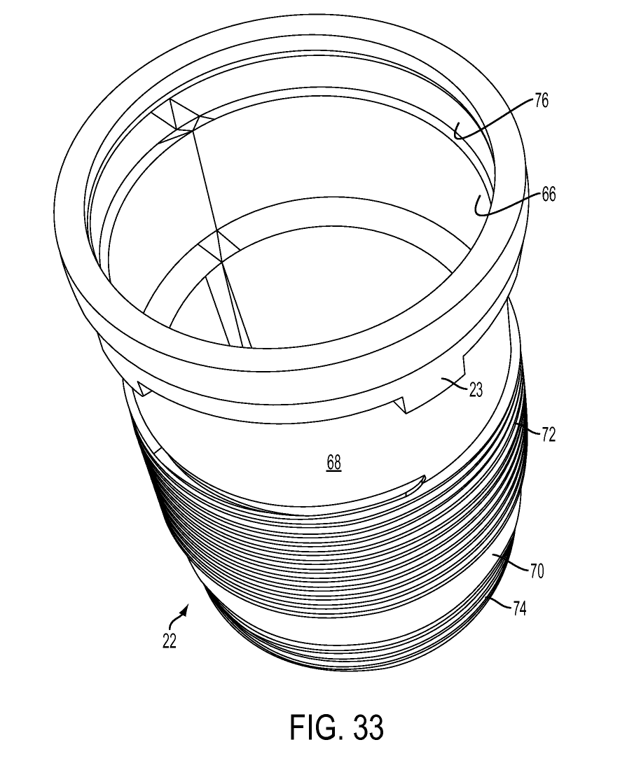

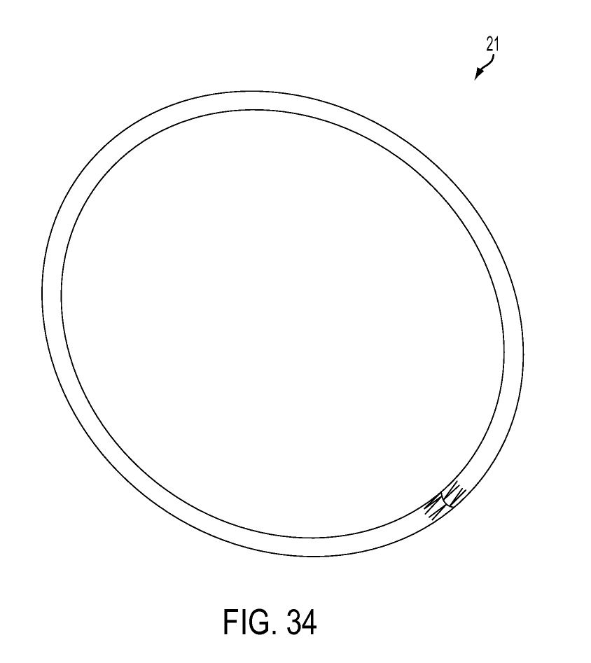

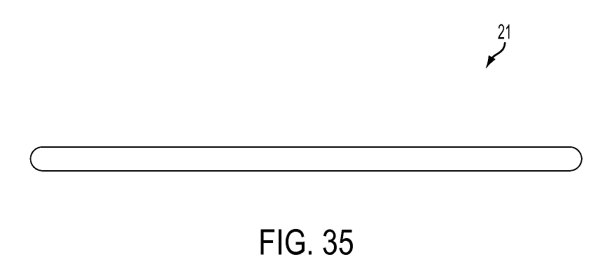

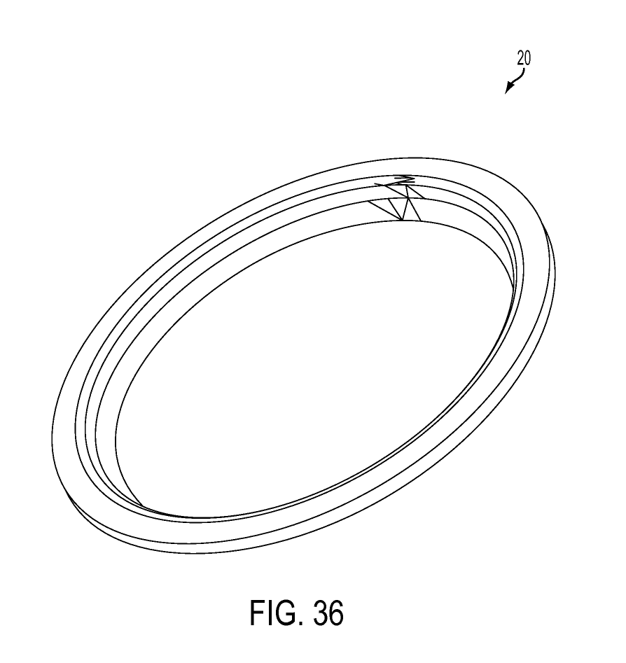

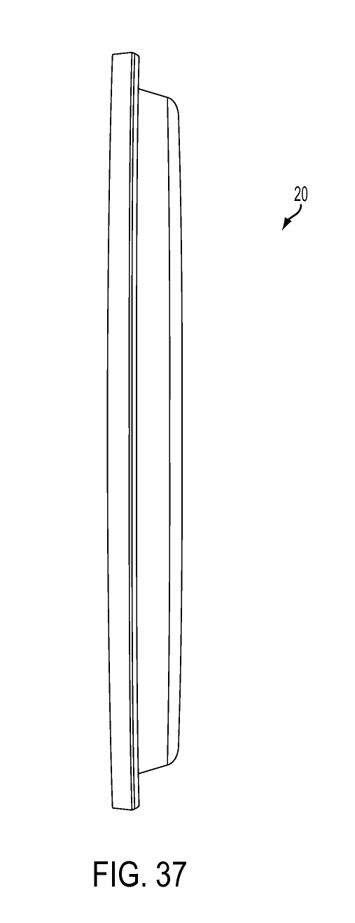

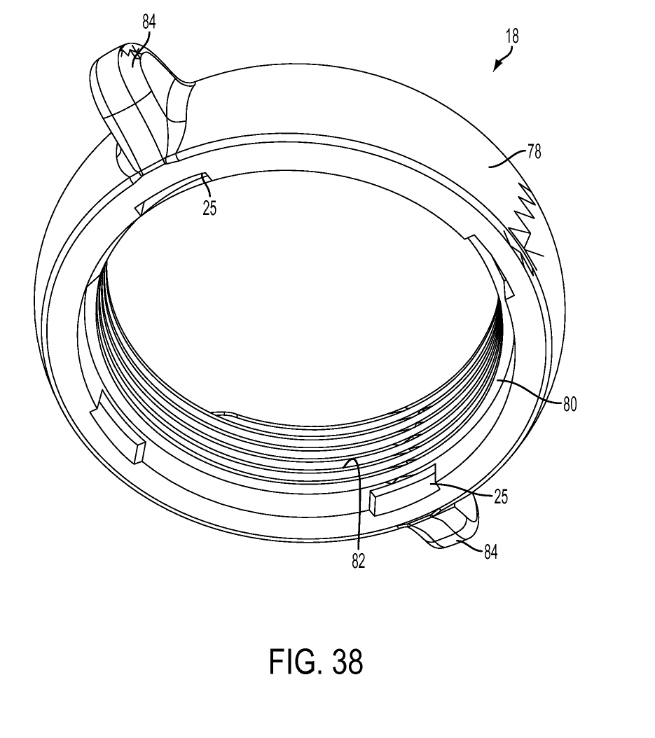

In one embodiment, referring to FIGS. 1-4, 14-16, 32, and 33, the cylindrical portion 22 is illustrated. The cylindrical portion 22 is used to connect the insert 12 to the service connection or conduit 26. The cylindrical portion 22 may comprise a bore 66 therethrough and an outer wall 68. The outer wall 68 may comprise a shoulder 70 and threads thereon. A first set of threads 72 may be positioned on a first side of the shoulder 70 and a second set of threads 74 may be positioned on a second side of the shoulder 70. The first set of threads 72 may be used to threadably engage the threaded portion 46 of the bore 44 of the insert 12. The shoulder 70 may define a surface configured to receive the second gasket 21 (see e.g., FIGS. 34 and 35). The second gasket 21 may be used to sealably engage a top portion of the insert 12 when the first set of threads 72 is engaged, or fully engaged, with the threaded portion 46 of the bore 44. In one embodiment, the second gasket 21 may create a water-tight connection between the insert 12 and the cylindrical portion 22. The first gasket 20 (see e.g., FIGS. 36 and 37) may be used to seal the cylindrical portion 22 to an end or end portion of a service or conduit connection 26. The first gasket 20 may be configured to be positioned within, or partially within, a groove 76 defined in the bore 66. The purpose of the groove 76 may be to retain the first gasket 20 in position within the bore 66.

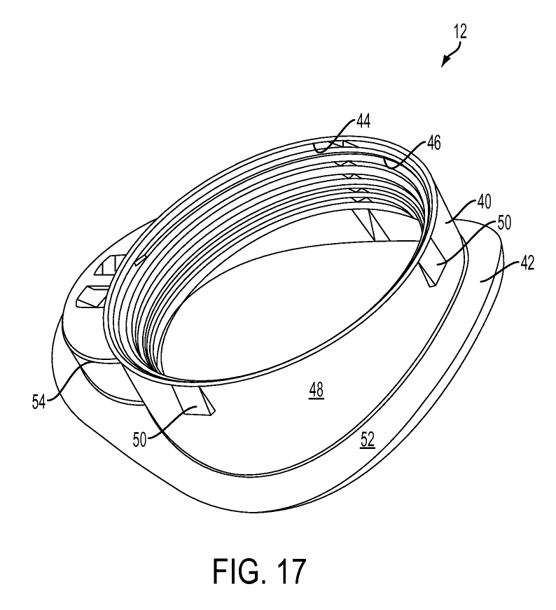

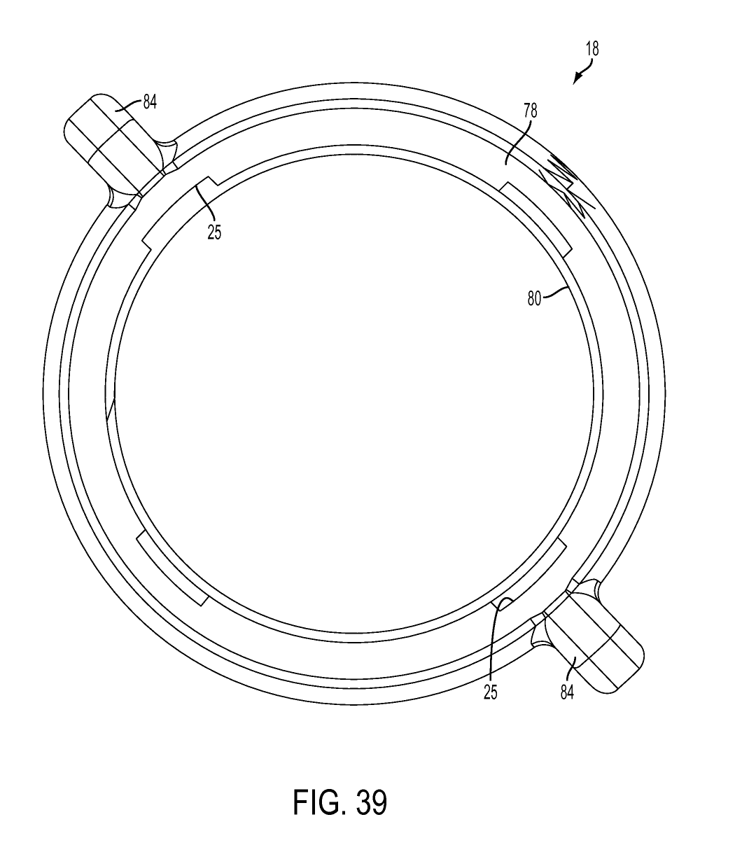

In various embodiments, referring to FIGS. 1-4, 14-16, 32, 33, 38, and 39, the second set of threads 74 may be configured to be engaged with the threaded fastening member 18 such that the threaded fastening member 18 may be used to tighten the connection between the insert 12 and the cylindrical portion 22 as the threaded fastening member 18 is rotated and/or moved. In one embodiment, the threaded fastening member 18 may comprise a ring 78 defining a bore 80 therethrough. The bore 80 may define a threaded sidewall 82 or a sidewall having a threaded portion. One or more handle portions 84 may extend outwardly from the ring 78. The handle portions 84 allow the threaded fastening member 18 to be rotated while engaged with the second set of threads 74. In one embodiment, the threaded fastening member 18 may be rotated and tightened as illustrated in FIG. 16. The threaded fastening member 18 allows the cylindrical portion 22 to be tightened onto the threaded portion 46 of the insert 12, thereby compressing the second gasket 21 and creating a sealed engagement or a water-tight engagement between the cylindrical portion 22 and the insert 12.

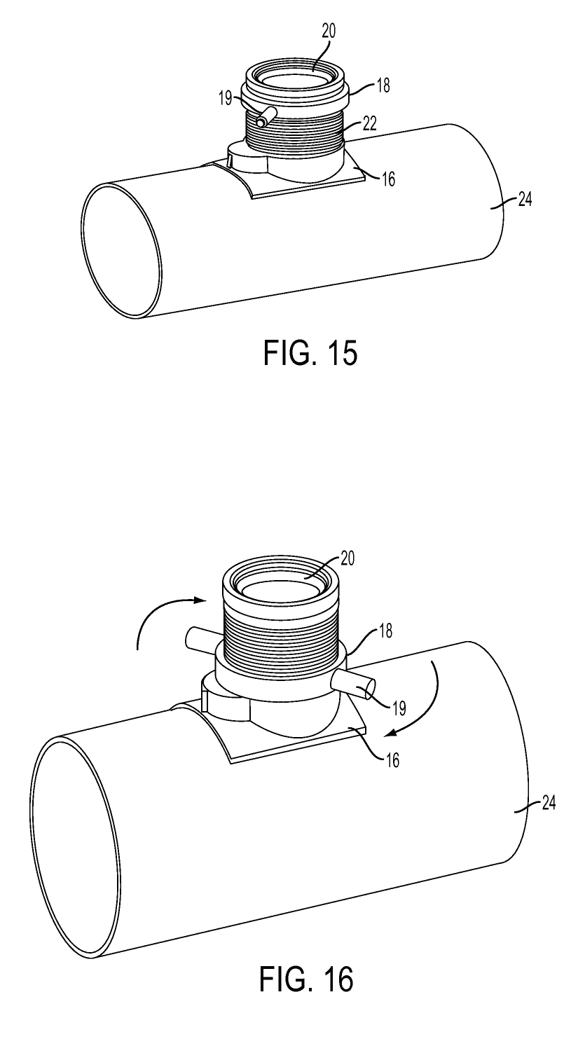

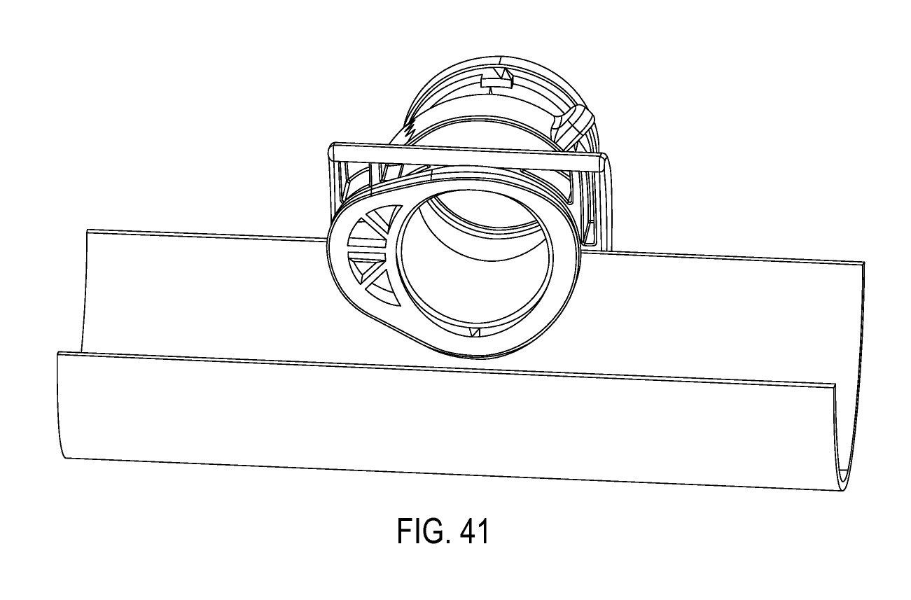

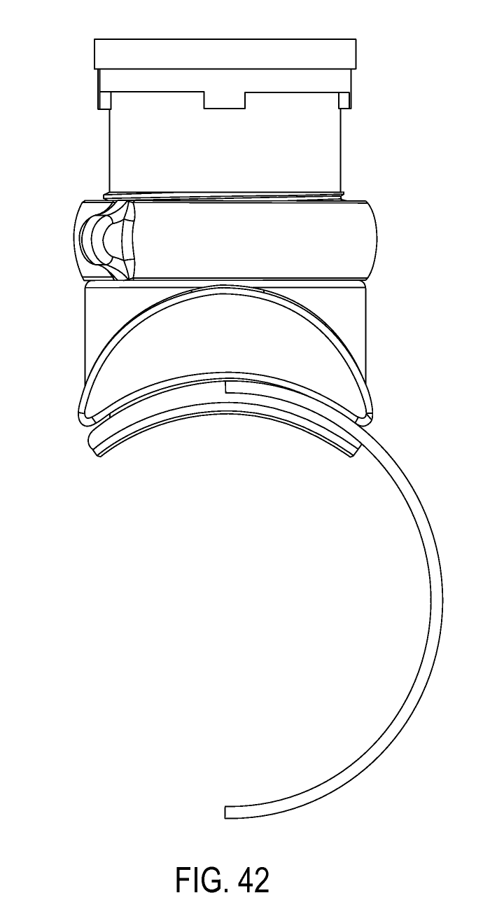

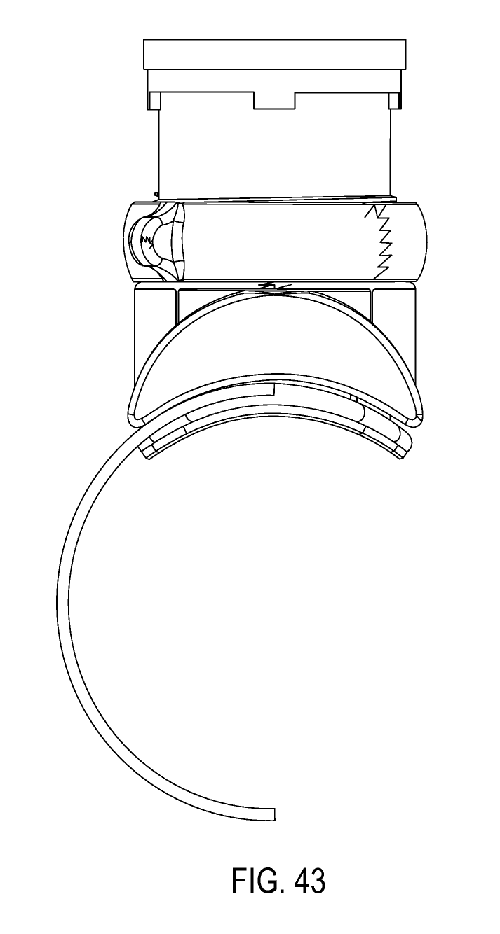

In one embodiment, referring to FIGS. 1-4, 14-16, 32, 33, and 38-43, the cylindrical portion 22 may comprise projections 23 thereon that are configured to interlock with recesses 25 on the threaded fastening member 18. Such interlocking may enable solid tightening of the second set of threads 74 with the threaded portion 46 of the insert 12 (see, e.g., FIGS. 14 and 15). After the second set of threads 74 has been tightened with the threaded portion 46 of the insert 12, the threaded fastening member 18 may be moved, rotated, and/or threaded into the position illustrated in FIG. 16 and tightened to compress the gasket insert 14 against the inner wall of the main conduit 24. In other various embodiments, the cylindrical portion 22 may be temporarily interlocked with the threaded fastening member 18 using other keyed portions, guide members, and/or interlocking members, for example.

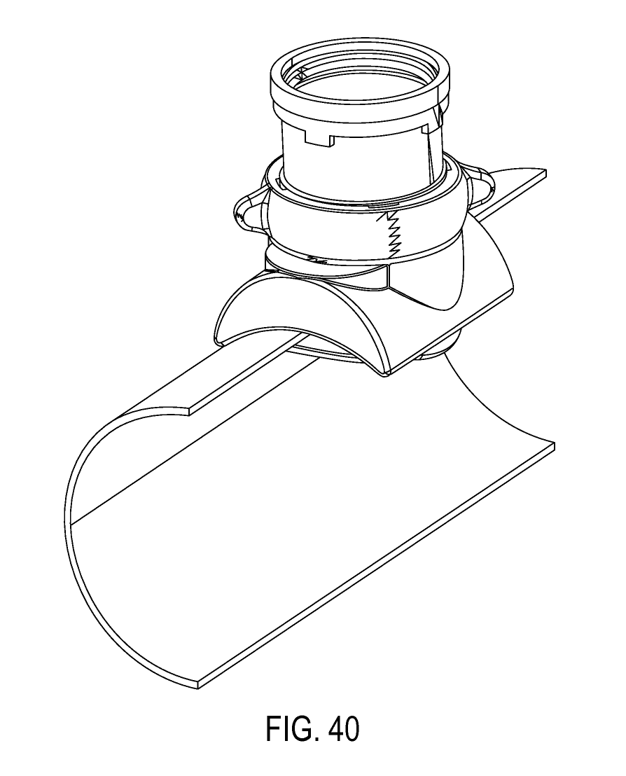

In one embodiment, referring to FIGS. 40-43, assembled views of connector assemblies on a cut-away main conduit are illustrated.

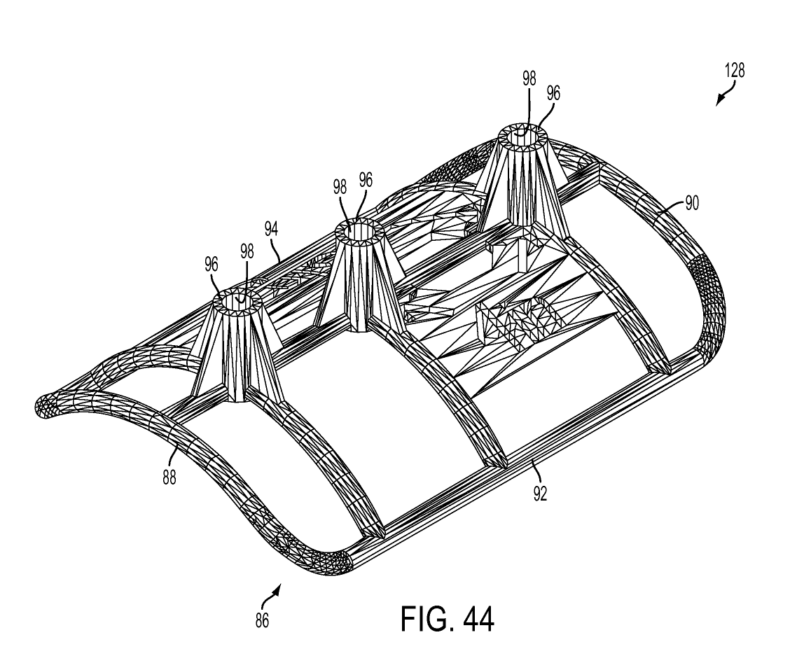

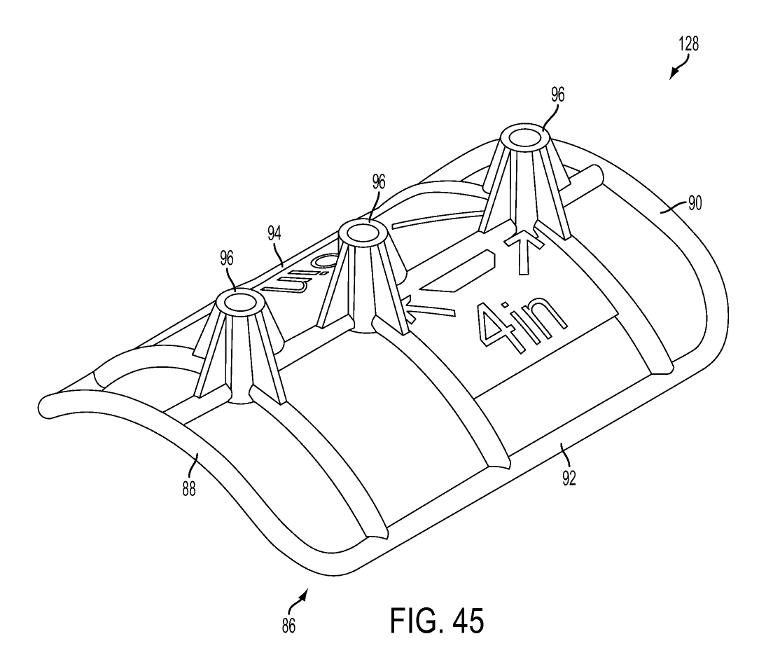

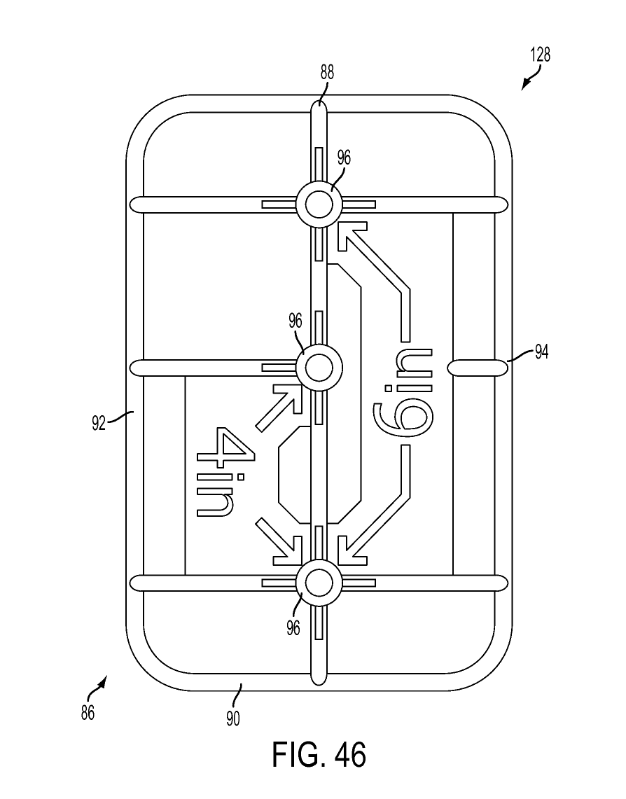

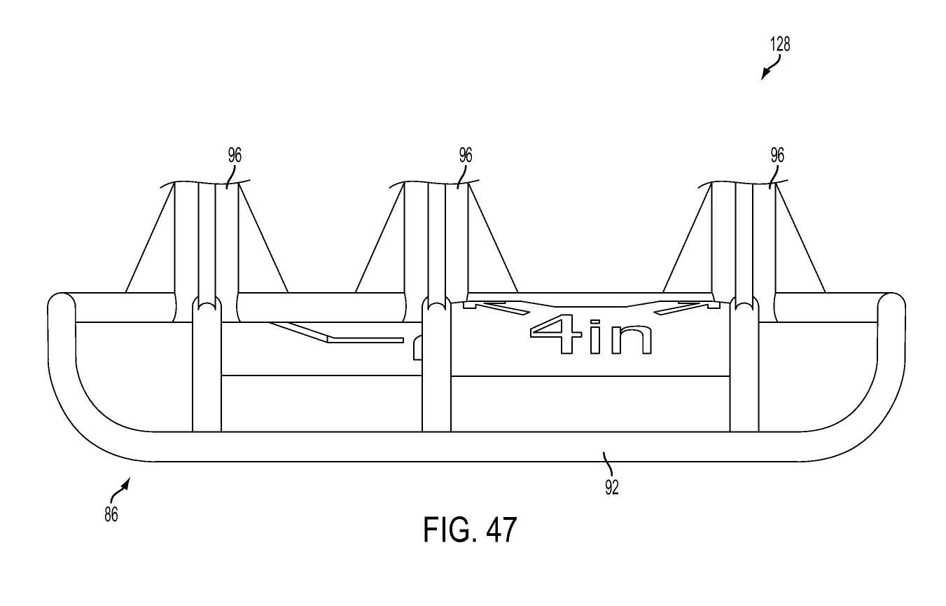

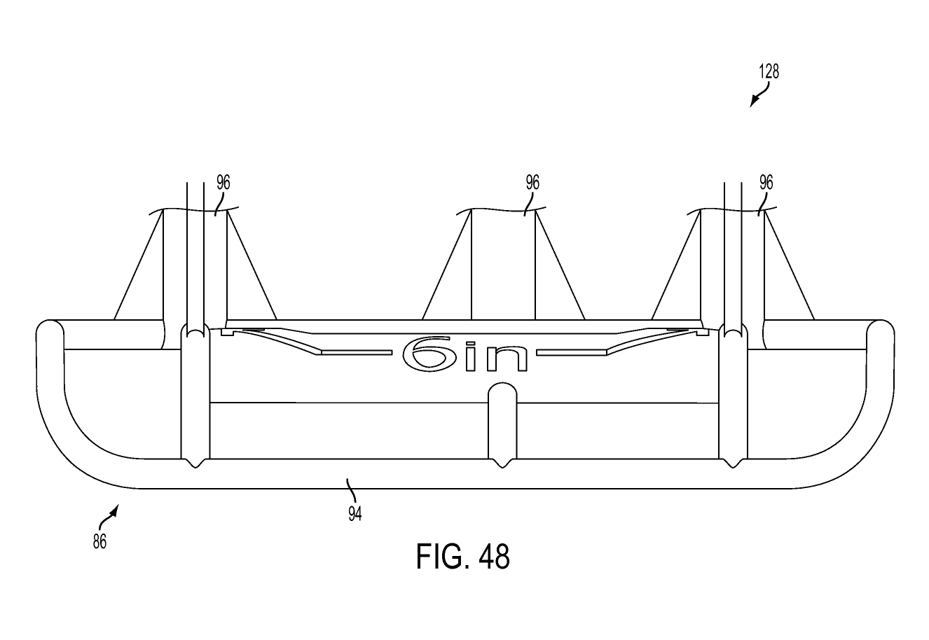

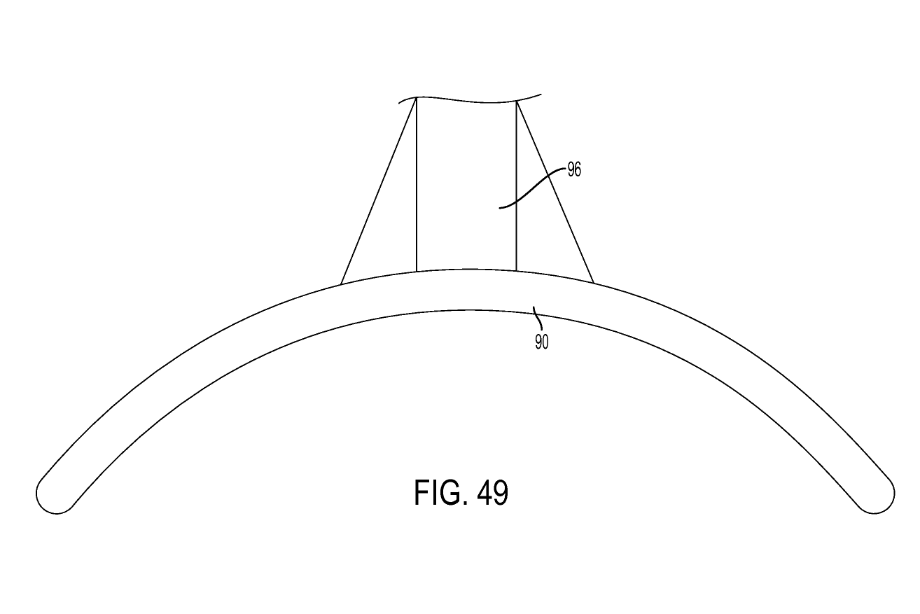

In one embodiment, a drill guide may be a separate component from the sleeve 16. In various embodiments, referring to FIGS. 44-49, a drill guide 128 is provided. The drill guide 128 may be positioned on an outer surface of a main conduit for drilling pilot holes in the main conduit. Owing to the configuration of the drill guide 128, the pilot holes will be positioned along a longitudinal axis of the main conduit and define a bore that is perpendicular to, or substantially perpendicular to, the longitudinal axis of the main conduit. In one embodiment, the drill guide 128 may comprise a support member 86 comprising a first arcuate end portion 88, a second arcuate end portion 90, a first substantially flat or flat side portion 92, and a second substantially flat or flat side portion 94. The support member 86 may comprise one or more drill bit receiving member 96 positioned thereon, formed therewith, or attached thereto. In one embodiment, the support member 86 may comprise two drill bit receiving members 96 or three drill bit receiving member 96, for example. In other various embodiments, more than three drill bit receiving members 96 may be provided on the support member based on a particular need or application. Each drill bit receiving member 96 may define a bore 98 therethrough that is configured to receive a drill bit. The bore 98 and the positioning of the support member 86 on the main conduit may allow a pilot hole to be drilled in the main conduit that is perpendicular, or substantially perpendicular, to the longitudinal axis of the main conduit. The pilot holes may then be used as a guide when cutting the first hole 36 and the second hole 38 in the main conduit.

In one embodiment, a first drill bit receiving member 96 may be positioned on the support member away from, or spaced apart from, a second drill bit receiving member. In various embodiments, the first drill bit receiving member 96 may be positioned a first distance from a longitudinal midpoint of the support member 86 and the second drill bit receiving member 96 may be positioned a second distance from the longitudinal midpoint of the support member 86. The first distance may be greater than, the same as, or less than the second distance. In any event, the first and second drill bit receiving members 96 should be positioned on the support member 86 such that a first pilot hole may be drilled at a center point of first hole to be cut in the main conduit and, such that a second pilot hole may be drilled at a center point of the second hole to be cut in the main conduit.

In one embodiment, referring to FIGS. 44-48, the drill guide 128 may comprise indicia to indicate to a user which two drill bit receiving members 96 should be used for differently sized service conduit installations. For a connection of a four inch service conduit to a main conduit, an installer may drill pilot holes through the drill bit receiving members 96 where indicated with a “4 in.” Likewise, for a connection of a six inch service conduit to a main conduit, an installer may drill pilot holes through the drill bit receiving members 96 where indicated with a “6 in,” for example. As such, the same drill guide 128 may be used regardless of whether an installer is connecting a four inch service conduit or a six inch service conduit to a main conduit, owing to the provision of three drill bit receiving members 96 on the support member. In other various embodiments, the spacing between the bores of the drill bit receiving members 96 may be suited for service conduit connections of other diameters. In one embodiment, more than three drill bit receiving members 96 may be provided, such that the drill guide 128 may be universal for any diameter service conduit connection.

In one embodiment, a connector assembly for connecting a second conduit to a first conduit is provided. The connector assembly may comprise a rigid insert comprising a flange and a first annular portion extending from the flange. The first annular portion may define a bore comprising a threaded portion. The flange may be configured to be positioned within the first conduit through an opening formed in a wall of the first conduit. The rigid insert may also comprise a lobe portion extending from the flange and positioned proximate to the first annular portion. The connector assembly may comprise a universal sleeve comprising an arcuate base. The arcuate base may be configured to be substantially flush with an outer perimeter of the first conduit proximate to the opening when the first conduit comprises a diameter of X. The arcuate base may be configured to be arched from the outer perimeter of the first conduit proximate to the opening when the first conduit comprises a diameter of X1 or greater. The diameter X1 may be greater than the diameter X. The diameter X may be about eight inches and the diameter X1 may be in the range of about ten inches to about twelve inches. The universal sleeve may also comprise a second annular portion extending from the arcuate base. An aperture may be defined through the arcuate base and the second annular portion. The connector assembly may comprise a cylindrical portion comprising threads thereon. The threads may be configured to be threadably engaged with the threaded bore of the rigid insert. The cylindrical portion may be configured to receive an end or end portion of a service conduit.

In one embodiment, a connector assembly kit for connecting a second conduit to a first conduit is provided. The connector assembly kit may comprise a plurality of rigid inserts comprising a first rigid insert having a first configuration for use with a conduit having a first diameter, a second rigid insert having a second configuration for use with a conduit having a second diameter, a third rigid insert having a third configuration for use with a conduit having a third diameter, and a fourth rigid insert having a fourth configuration for use with a conduit having a fourth diameter. Each rigid insert may comprise a rigid flange and a first rigid annular portion extending from the rigid flange. The first rigid annular portion may define a bore comprising a threaded portion. The rigid flange is configured to be positioned within the first conduit through an opening formed in a wall of the first conduit. The connector assembly kit may also comprise a universal sleeve that may comprise an arcuate base. A portion of the arcuate base may be configured to contact an outer perimeter of the first conduit proximate to the opening. The universal sleeve may also comprise a second annular portion extending from the arcuate base. An aperture may be defined through the arcuate base and the second annular portion. The universal sleeve may be configured to be positioned over any of the first rigid insert, the second rigid insert, the third rigid insert, the fourth rigid insert, and/or any other suitable rigid inserts. The connector assembly kit may also comprise a cylindrical portion comprising threads thereon. The threads may be configured to threadably engage the threaded portion of the bore. The cylindrical portion may be configured to receive an end or end portion of a service conduit. The connector assembly kit may also comprise a threaded fastening member configured to be threadably engaged with the threads and a drill guide that may comprise a support member and at least one drill bit receiving member defining a bore therein. The first diameter may be about eight inches or about ten inches. The second diameter may be one of in the range of about ten inches to about twelve inches or about twelve inches. The third diameter may be in the range of about fifteen inches to about twenty-one inches or to about twenty-four inches. The fourth diameter may be in the range of about twenty-four inches or about twenty-seven inches to about forty-two inches or greater. Other suitably sized inserts are also within the scope of the present disclosure.

In one embodiment, the components of the connector assemblies and connector assembly kits of the present disclosure may be comprised of PVC, CPVC, ABS, plastic, metal, and/or other suitable materials. In various embodiments, the insert gasket 14, the first gasket 20 and the second gasket 21 may be comprised of an elastomer or a rubber material, for example. Those of skill in the art will recognize that other suitable materials may be used for any of the various components of the connector assemblies and connector assembly kits of the present disclosure and that the use of such materials is within the scope of the present disclosure.

In one embodiment, a method of attaching a service conduit to a conduit having a longitudinal axis using a connection assembly kit is provided. The method may comprise positioning a drill guide on the conduit such that a longitudinal axis of the drill guide is substantially parallel with the longitudinal axis of the conduit, drilling a first pilot hole in the conduit using a drill bit and a first bore in the drill guide, drilling a second pilot hole in the conduit using the drill bit and a second bore in the drill guide, and removing the drill guide from the conduit. The method may also comprise cutting a first hole in the conduit using the first pilot hole and cutting a second hole in the conduit using the second pilot hole. The second hole may overlap the first hole. In one embodiment, the first hole and the second hole may be round, or substantially round. In various embodiments, the first hole may be cut with a first hole saw prior to cutting the second hole with a second hole saw and the first hole may have a smaller diameter than the second hole. The method may also comprise inserting a rigid insert into the aperture formed by the first hole and the second hole, positioning a rigid flange of the rigid insert within the conduit, and attaching a universal sleeve to a portion of the rigid insert that extends outside of the conduit. The method may also comprise attaching a cylindrical portion to the rigid insert and inserting an end of the service conduit into a bore defined by the cylindrical portion to sealably connect the conduit and the service conduit.

All documents cited in the Detailed Description are, in relevant part, incorporated herein by reference in their entirety. The citation of any document is not to be construed as an admission that it is prior art with respect to the present disclosure. To the extent that any meaning or definition of a term in the present disclosure conflicts with any meaning or definition of the term in a document incorporated by reference, the meaning or definition assigned to the term in the present disclosure shall govern.

While particular non-limiting embodiments of the present disclosure have been illustrated and described, those of skill in the art will recognize that various other changes and modifications may be made without departing from the spirit and scope of the present disclosure. It is therefore intended to cover in the appended claims all such changes and modifications that are within the scope of the present disclosure.

What is claimed is:

1. A connector assembly for connecting a second conduit to a first conduit, the connector assembly comprising:
a rigid insert comprising:
a flange;
a first annular portion extending from the flange, wherein the first annular portion defines a bore comprising a threaded portion, wherein the flange is configured to be positioned within the first conduit through an opening formed in a wall of the first conduit; and
a lobe portion extending from the flange and positioned proximate to the first annular portion;
a sleeve comprising:
an arcuate base, wherein a portion of the arcuate base is configured to contact an outer perimeter of the first conduit proximate to the opening; and
a second annular portion extending from the arcuate base, wherein an aperture is defined through the arcuate base and the second annular portion;
a cylindrical portion comprising threads thereon, wherein the threads are configured to threadably engage the threaded portion of the bore, and wherein the cylindrical portion is configured to receive an end portion of the second conduit; and
a threaded fastening member configured to be threadably engaged with the threads.

2. The connector assembly of claim 1, wherein the sleeve comprises a second lobe portion positioned proximate to the second annular portion, and wherein the second lobe portion is configured to at least partially be positioned over the first lobe portion.

3. The connector assembly of claim 1, wherein an outer perimeter of the first annular portion comprises a retaining member configured to be engaged with the wall of the first conduit, and wherein the connector assembly comprises an insert gasket configured to be positioned on the flange.

4. The connector assembly of claim 1, wherein a flexible retaining member is attached to or engaged with the rigid insert.

5. The connector assembly of claim 1, wherein the threaded fastening member comprises a ring comprising a handle portion extending outwardly therefrom.

6. The connector assembly of claim 1, comprising a drill guide one of removably attached to and positionable on the second annular portion.

7. The connector assembly of claim 6, wherein the drill guide comprises a support member comprising two drill bit receiving members thereon.

8. The connector assembly of claim 6, wherein the drill guide comprises:
a support member;
a first drill bit receiving member positioned on the support member, wherein the first drill bit receiving member is positioned a first distance from a midpoint of the support member; and
a second drill bit receiving member positioned on the support member, wherein the second drill bit receiving member is positioned a second distance from a midpoint of the support member, and wherein the first distance is greater than the second distance.

9. The connector assembly of claim 1, wherein the cylindrical portion comprises a shoulder, wherein the threads comprise a first set of threads and a second set of threads, wherein the first set of threads is positioned on a first side of the shoulder and is configured to be engaged with the threaded bore, and wherein the second set of threads is positioned on a second side of the shoulder and is configured to be engaged with the threaded fastening member.

10. A connector assembly for connecting a second conduit to a first conduit, the connector assembly comprising:
an insert comprising:
a first rigid flange; and
a first annular portion extending from the first rigid flange, wherein the first annular portion defines a bore comprising a threaded portion, wherein the first rigid flange is configured to be positioned within the first conduit through an opening formed in a wall of the first conduit without deformation;
a sleeve comprising:
an arcuate base;
a second annular portion extending from the arcuate base, wherein an aperture is defined through the arcuate base and the second annular portion; and
a lobe portion positioned proximate to the second annular portion;
a cylindrical portion comprising threads positioned thereon, wherein the threads are configured to threadably engage the threaded portion of the bore, and wherein the cylindrical portion is configured to receive an end portion of the second conduit; and
a threaded fastening member configured to be threadably engaged with the threads.

11. A connector assembly kit for connecting a second conduit to a first conduit, the connector assembly kit comprising:
a plurality of rigid inserts comprising:
a first rigid insert having a first configuration for use with a conduit having a first diameter; and
a second rigid insert having a second configuration for use with a conduit having a second diameter;
each rigid insert comprising:
a rigid flange; and
a first rigid annular portion extending from the rigid flange, wherein the first rigid annular portion defines a bore comprising a threaded portion, wherein the rigid flange is configured to be positioned within the first conduit through an opening formed in a wall of the first conduit;
a universal sleeve comprising:
an arcuate base, wherein a portion of the arcuate base is configured to contact an outer perimeter of the first conduit proximate to the opening; and
a second annular portion extending from the arcuate base, wherein an aperture is defined through the arcuate base and the second annular portion;
a cylindrical portion comprising threads thereon, wherein the threads are configured to threadably engage the threaded portion of the bore, and wherein the cylindrical portion is configured to receive an end portion of the second conduit;
a threaded fastening member configured to be threadably engaged with the threads; and
a drill guide comprising:
a support member; and
a drill bit receiving member defining a bore therein.

12. The connector assembly kit of claim 11, wherein the drill bit receiving member is a first drill bit receiving member, and wherein the support member comprises:
a first arcuate end portion;
a second arcuate end portion;
a first substantially flat side portion;
a second substantially flat side portion; and
a second drill bit receiving member positioned away from the first drill bit receiving portion.

13. The connector assembly kit of claim 11, wherein each rigid insert comprises a first lobe portion extending from the rigid flange and positioned proximate to the first annular portion, wherein the sleeve comprises a second lobe portion positioned proximate to the second annular portion, and wherein the second lobe portion is configured to at least partially surround the first lobe portion when the sleeve is positioned over the rigid insert.

14. The connector assembly kit of claim 11, wherein the first diameter is in the range of about eight inches to about twelve inches, and wherein the second diameter is in the range of about fifteen inches to about forty-two inches.

15. The connector assembly kit of claim 11, wherein the plurality of rigid inserts comprise:
a third rigid insert having a third configuration for use with a third conduit having a third diameter; and
a fourth rigid insert having a fourth configuration for use with a fourth conduit having a fourth diameter, wherein the universal sleeve is configured to be positioned over any of the first rigid insert, the second rigid insert, the third rigid insert, and the fourth rigid insert.

16. A connector assembly for connecting a second conduit to a first conduit, the connector assembly comprising:
a rigid insert comprising:
a flange;
a first annular portion extending from the flange, wherein the first annular portion defines a bore comprising a threaded portion, wherein the flange is configured to be positioned within the first conduit through an opening formed in a wall of the first conduit; and
a lobe portion extending from the flange and positioned proximate to the first annular portion;
a universal sleeve comprising:
an arcuate base, wherein the arcuate base is configured to be substantially flush with an outer perimeter of the first conduit proximate to the opening when the first conduit comprises a diameter of X, and wherein the arcuate base is configured to be arched from the outer perimeter of the first conduit proximate to the opening when the first conduit comprises a diameter of X1 or greater, and wherein the diameter X1 is greater than the diameter X; and
a second annular portion extending from the arcuate base, wherein an aperture is defined through the arcuate base and the second annular portion; and
a cylindrical portion comprising threads thereon, wherein the threads are configured to threadably engage the threaded bore, and wherein the cylindrical portion is configured to receive an end portion of the second conduit.

17. The connector assembly of claim 16, wherein the diameter X is about eight inches, and wherein the diameter X1 is in the range of about ten to about twelve inches.

18. A method of attaching a service conduit to a conduit having a longitudinal axis using a connector assembly kit, the method comprising:
positioning a drill guide on the conduit such that a longitudinal axis of the drill guide is substantially parallel with the longitudinal axis of the conduit;
drilling a first pilot hole in the conduit using a drill bit and a first bore in the drill guide;
drilling a second pilot hole in the conduit using the drill bit and a second bore in the drill guide;
removing the drill guide from the conduit;
cutting a first round hole in the conduit using the first pilot hole;
cutting a second round hole in the conduit using the second pilot hole, wherein the second round hole overlaps the first round hole;
inserting a rigid insert into the aperture formed by the first round hole and the second round hole;
positioning a rigid flange of the rigid insert within the conduit; and
positioning a universal sleeve over a portion of the rigid insert that extends outside of the conduit.

19. The method of claim 18, comprising attaching a cylindrical portion to the rigid insert and inserting an end portion of the service conduit into a bore defined by the cylindrical portion to sealably connect the conduit and the service conduit.

20. The method of claim 18, comprising cutting the first round hole with a first hole saw prior to cutting the second round hole with a second hole saw, wherein the first round hole has a smaller diameter than the second round hole.
